(19) United States
(12) Patent Application Publication
(10) Pub. No.: US 2009/0185572 A1
(43) Pub. Date: Jul. 23, 2009

(54) RELAY APPARATUS AND METHOD FOR NOTIFYING INFORMATION

(75) Inventor: Kensuke Yasuma, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/354,619

(22) Filed: Jan. 15, 2009

(30) Foreign Application Priority Data
Jan. 17, 2008 (JP) 2008-008028

(51) Int. Cl. H04L 12/56

(52) U.S. Cl. 370/401

(57) ABSTRACT

A relay apparatus connected to a first network and configured to construct a connection between the first network and another network so that a communication packet can be transmitted between the first network and the another network includes a relay unit configured to relay communication data received from a communication apparatus on the first network to a communication apparatus on the another network via the connection, an acquisition unit configured to acquire information corresponding to a data length of a communication packet that can be transmitted via the connection without being divided according to a change of connection status of the another network, and a notification unit configured to notify the information acquired by the acquisition unit to the communication apparatus on the first network.

### BACKGROUND OF THE INVENTION

1. Field of the Invention

The present invention relates to a method for determining the data length of a communication packet transmitted in a communication performed via a network.

2. Description of the Related Art

Conventionally, in a communication performed via a network, if the size of a communication packet exceeds a Maximum Transmission Unit (MTU), which indicates the maximum data length of a communication packet that can be transmitted by an intermediary apparatus, such as a router apparatus, then the communication packet whose size exceeds the MTU is divided into a size equal to or smaller than the MTU by the intermeidary apparatus.

The above-described case may frequently arise in an environment in which a header is added to a communication packet, for example, in an environment of Virtual Private Network (VPN), in which a plurality of networks are mutually logically connected. In order to solve such a problem, a conventional method calculates an optimum MTU by using a flag for inhibiting dividing a communication packet.

In this regard, Japanese Patent Application Laid-Open No. 2004-349958 discusses a conventional method for detecting an optimum MTU by transmitting a packet for which a division inhibiting flag is set and by receiving error information transmitted from an intermediary apparatus.

Furthermore, Japanese Patent Application Laid-Open No. 2005-151021 discusses a method for transmitting an MTU in the VPN environment by using Router Advertisement (RA) of Internet Protocol Version 6 (IPv6).

However, if an MTU is changed in a communication performed via the network and the communication cannot be performed by using a packet of the size determined according to the changed MTU, then throughput may decrease. For example, presume that a logical connection via the VPN has been constructed and performed among a plurality of networks. If another network is newly connected to (participates) the VPN connection in this case, then an MTU is changed.

Furthermore, if a VPN connection has been constructed and performed among a plurality of networks and the connection with some of the plurality of networks that have been VPN-connected is discontinued, then the MTU is changed. In this case, for example, if the MTU is changed to an MTU smaller than the previously set MTU and if a communication is performed according to the previously set MTU (MTU before the change), then the transmitted packet may be divided by an intermeidary apparatus.

Furthermore, for example, if the size of the MTU has been changed (increased) and the communication apparatus does not detect the change in this case, then the communication may be continued with the small-sized communication packet.

### SUMMARY OF THE INVENTION

The present invention is directed to a method for performing, if an MTU has been changed, a communication with a packet size determined according to the MTU that has been changed.

According to an aspect of the present invention, a relay apparatus connected to a first network and configured to construct a connection between the first network and another network so that a communication packet can be transmitted between the first network and the another network includes a relay unit configured to relay communication data received from a communication apparatus on the first network to a communication apparatus on the another network via the connection, an acquisition unit configured to acquire information corresponding to a data length of a communication packet that can be transmitted via the connection without being divided according to a change of connection status of the another network, and a notification unit configured to notify the information acquired by the acquisition unit to the communication apparatus on the first network. According to another aspect of the present invention, a relay apparatus connected to a first network and configured to construct a connection between the first network and a second network so that a communication packet can be transmitted between the first network and the second network, the relay apparatus includes a relay unit configured to relay communication data received from a communication apparatus on the first network to a communication apparatus on the second network via a second relay apparatus connected to the second network, an acquisition unit configured to, based on connection information notified from the second relay apparatus according to a change of connection status of the second relay apparatus between the second network and another network, acquire information corresponding to a data length of a communication packet that can be transmitted via the connection after the change of connection status without being divided, and a notification unit configured to notify the information acquired by the acquisition unit to the communication apparatus on the first network.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the present invention and, together with the description, serve to describe the principles of the present invention.

FIG. 1 illustrates an example of a configuration of a network system according to a first exemplary embodiment of the present invention.

FIG. 2 illustrates an exemplary hardware configuration of a network-connected apparatus according to an exemplary embodiment of the present invention.

FIG. 3 illustrates an exemplary hardware configuration of a logical network control apparatus according to an exemplary embodiment of the present invention.

FIG. 4 illustrates an exemplary module configuration of a network-connected apparatus according to an exemplary embodiment of the present invention.

FIG. 5 illustrates an exemplary module configuration of a logical network control apparatus according to an exemplary embodiment of the present invention.

FIG. 6 is a flow chart that illustrates an example of a flow of processing performed related to a request for registering an event performed by a network-connected apparatus according to an exemplary embodiment of the present invention.

FIG. 7 is a flow chart that illustrates an example of a flow of processing for receiving a request for registering an event performed by the logical network control apparatus according to an exemplary embodiment of the present invention.

FIG. 8 is a flow chart that illustrates an example of a flow of processing for receiving an MTU notification event performed by a network-connected apparatus according to an exemplary embodiment of the present invention.

FIG. 9 is a flow chart that illustrates an example of a flow of receiving processing performed by a logical network control apparatus when a request related to a VPN connection is issued according to an exemplary embodiment of the present invention.

FIG. 10 illustrates an example of a configuration of a network system according to a second exemplary embodiment of the present invention.

FIG. 11 illustrates an example of an MTU list that a logical network control apparatus stores according to an exemplary embodiment of the present invention.

FIG. 12 illustrates an example of an MTU list that a logical network control apparatus stores according to an exemplary embodiment of the present invention.

FIG. 13 illustrates an example of an MTU list that a logical network control apparatus stores according to an exemplary embodiment of the present invention.

FIG. 14 illustrates an example of a configuration of a network system according to a third exemplary embodiment of the present invention.

FIG. 15 is a flow chart that illustrates an example of processing performed by the network-connected apparatus at the start of a communication constructed based on a VPN connection according to the third exemplary embodiment of the present invention.

FIG. 16 is a flow chart that illustrates an example of processing for starting a communication performed by the logical network control apparatus according to the third exemplary embodiment of the present invention.

FIG. 17 illustrates an example of an MTU list that the logical network control apparatus stores according to an exemplary embodiment of the present invention.

FIG. 18 illustrates an example of an MTU list that the logical network control apparatus stores according to an exemplary embodiment of the present invention.

FIG. 19 is a sequence chart that illustrates an example of a flow of processing for registering an MTU notification event according to an exemplary embodiment of the present invention.

FIG. 20 illustrates an example of a flow of VPN connection processing according to an exemplary embodiment of the present invention.

FIG. 21 illustrates an example of a flow of processing for discontinuing the VPN connection according to an exemplary embodiment of the present invention.

FIG. 22 illustrates an example of a flow of processing performed by the logical network control apparatus when a request for constructing or discontinuing a VPN connection is received according to an exemplary embodiment of the present invention.

FIG. 23 is a flow chart that illustrates an example of a flow of processing for receiving connection information performed by the logical network control apparatus according to an exemplary embodiment of the present invention.

### DETAILED DESCRIPTION OF THE EMBODIMENTS

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

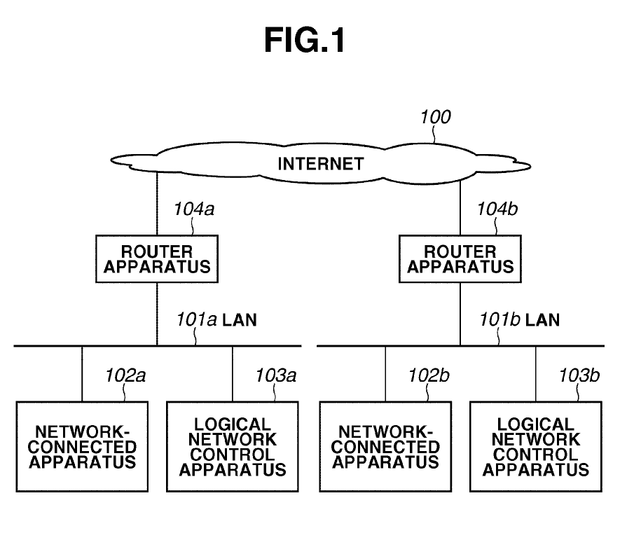

A first exemplary embodiment of the present invention will now be described below. FIG. 1 illustrates an example of a configuration of a network system according to the first exemplary embodiment of the present invention. The network system includes the Internet 100. Here, it is to be noted that the Internet 100 according to the present exemplary embodiment is not limited to the Internet. That is, a wide area network (WAN), a local area network (LAN), or an ad hoc network (or a combination thereof) can be used as the Internet 100.

Furthermore, the network system includes a LAN 101a (a first network). Here, note that the LAN 101a is not limited to a LAN. That is, a WAN or an ad hoc network (or a combination thereof) can be used.

Furthermore, a LAN 101b (another network) is a network having the same function as that of the LAN 101a (the first network). In addition, the network system includes a network-connected apparatus 102a. The network-connected apparatus 102a is connected to the LAN 101a (the first network) and performs a communication via the network by using a communication application.

Furthermore, a network-connected apparatus 102b is connected to the LAN 101b (another network) and performs a communication via the network by using a communication application. In the present exemplary embodiment, the network-connected apparatus 102a and the network-connected apparatus 102b are the communication apparatuses having similar functions.

Furthermore, the network system includes a logical network control apparatus 103a. The logical network control apparatus 103a is connected to the LAN 101a (the first network) and constructs a VPN connection according to a request by the network-connected apparatus 102a.

That is, the logical network control apparatus 103a logically connects the LAN 101a and another network so that a communication packet can be transmitted between the LAN 101a (the first network) and another network.

Furthermore, the network system includes a logical network control apparatus 103b. The logical network control apparatus 103b is connected to the LAN 101b (another network) and implements a VPN connection according to a request by the network-connected apparatus 102b.

In the present exemplary embodiment, the logical network control apparatus 103a and the logical network control apparatus 103b are the relay apparatuses having similar functions. Furthermore, the network system includes a router apparatus 104a. The router apparatus 104a is connected to each of the Internet 100 and the LAN 101a and controls the path for a packet.

Furthermore, the network system includes a router apparatus 104b. The router apparatus 104b is connected to each of the Internet 100 and the LAN 101b and controls the path for a packet. In the present exemplary embodiment, the router apparatus 104a and the router apparatus 104b are the network apparatuses having similar functions.

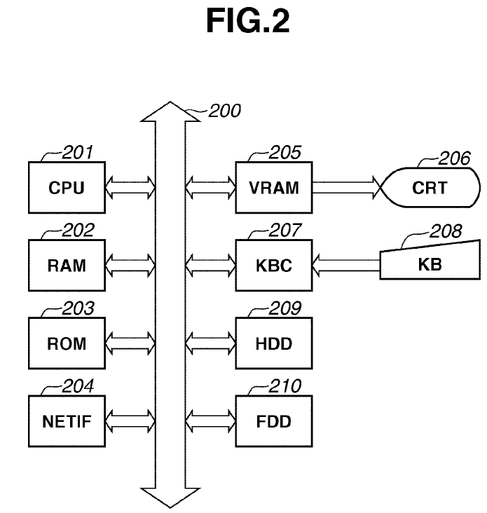

FIG. 2 illustrates an exemplary hardware configuration of the network-connected apparatus 102a according to the present exemplary embodiment. The network-connected apparatus 102a can be implemented not only by a computer system such as a personal computer (PC) but also by a terminal apparatus having a communication function for communicating with a logical network control apparatus, such as a work station, a notebook-sized PC, a palm top PC, various home appliances such as a television built in with a computer, a game machine having a data communication function, or a cellular phone (or by a combination thereof).

Referring to FIG. 2, the network-connected apparatus 102a includes a central processing unit (CPU) 201. The CPU 201 controls the operation of the entire computer system.

Furthermore, the network-connected apparatus 102a includes a random access memory (RAM) 202. The RAM 202 functions as a main memory, an area for storing a program to be executed, an area for executing the stored program, and a data area for the CPU 201.

Furthermore, the network-connected apparatus 102a includes a read-only memory (ROM) 203. The ROM 203 records a processing program executed by the CPU 201. The ROM 203 includes a program ROM that records basic software (an operating system (OS)), which is a system program for controlling the apparatuses in the computer system, and a data ROM that records information necessary to operate the system. Note that a hard disk drive (HDD) 209 can be used instead of the ROM 203.

Furthermore, the network-connected apparatus 102a includes a network interface (NETIF) 204. The NETIF 204 performs control for transmitting and receiving data within the computer system and diagnoses the status of connection performed via the network. Furthermore, the network-connected apparatus 102a includes a video RAM (VRAM) 205. The VRAM 205 rasterizes an image to be displayed on a screen of a cathode ray tube (CRT) display device 206 to display the operation status of the computer system and controls the display of the image.

In addition, the network-connected apparatus 102a includes the display device (CRT) 206. A CRT display, for example, can be used as the display device 206. Hereinbelow, the display device 206 is also referred to as a “CRT 206”.

Furthermore, the network-connected apparatus 102a includes a controller (keyboard controller (KBC)) 207 that controls an input signal from an external input device 208. In addition, the network-connected apparatus 102a includes the external input device (keyboard (KB)) 208 such as a keyboard. The external input device 208 receives an operation performed by a user of the computer system thereon.

Furthermore, the network-connected apparatus 102a includes a storage device 209 such as an hard disc drive (HDD) The storage device 209 is used to store an application program and data such as image information. Hereinafter, the storage device 209 is also referred to as a “HDD 209”.

The application program according to the present exemplary embodiment includes a software program used for performing processing for registering an event, which constitutes the present exemplary embodiment.

Furthermore, the network-connected apparatus 102a includes an external input/output apparatus 210. For example, the external input/output apparatus 210 inputs and outputs a removable storage medium such as a floppy disk (FD) or a compact disc-read only memory (CD-ROM). The external input/output apparatus 210 is used to read an application program from the medium. The external input/output apparatus 210 is hereinafter also referred to as a “floppy disk drive (FDD) 210”.

Note that the application program and the data to be stored on the HDD 209 can be stored on the FDD 210 and read therefrom, instead. Furthermore, the network-connected apparatus 102a includes an input/output bus (an address bus, a data bus, and a control bus) 200 that mutually connects the above-described units.

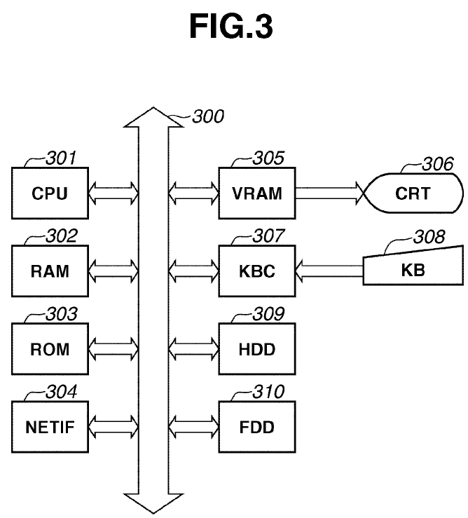

FIG. 3 illustrates an exemplary hardware configuration of the logical network control apparatus 103a according to the present exemplary embodiment. The logical network control apparatus 103a can be implemented not only by a computer system such as a personal computer (PC) but also by a terminal apparatus having a communication function for communicating with a logical network control apparatus such as a work station, a notebook-sized PC, a palm top PC, various home appliances such as a television built in with a computer, a game machine having a data communication function, or a cellular phone (or by a combination thereof).

Referring to FIG. 3, the logical network control apparatus 103a includes a CPU 301 that controls the operation of the entire computer system. A RAM 302 functions as a main memory, an area for storing a program to be executed, an area for executing the stored program, and a data area for the CPU 301.

Furthermore, the logical network control apparatus 103a includes a ROM 303 that records a processing program executed by the CPU 301. The ROM 303 includes a program ROM that records basic software (OS), which is a system program for controlling the apparatuses in the computer system, and a data ROM that records information necessary to operate the system. Note here that an HDD 309 can be used instead of the ROM 303.

Furthermore, the logical network control apparatus 103a includes a NETIF 304. The NETIF 304 performs control for transmitting and receiving data within the computer system and diagnoses the status of connection performed via the network.

That is, the logical network control apparatus 103a uses the NETIF 304 to transmit and receive, to and from the network-connected apparatus 102a on the LAN 101a (the first network), various messages for registering an event for notifying an MTU and notifying the MTU itself.

Furthermore, the logical network control apparatus 103a uses the NETIF 304 to transmit and receive various messages to and from the other logical network control apparatuses.

In addition, the logical network control apparatus 103a uses the NETIF 304 to relay communication data received from the network-connected apparatus 102a on the LAN 101a (the first network) to a communication apparatus on another network via a logical connection (VPN).

Moreover, the logical network control apparatus 103a uses the NETIF 304 to perform processing related to detecting a data length of a communication packet that can be transmitted via the logical connection without being divided when the status of the logical connection of another network is changed.

Furthermore, the logical network control apparatus 103a includes a VRAM 305. The VRAM 305 rasterizes an image displayed on a screen of a display apparatus (CRT) 306 that displays an operation status of the computer system and controls the display of the displayed image.

Furthermore, the logical network control apparatus 103a includes the display apparatus 306 such as a display. The display apparatus 306 is hereinafter also referred to as a “CRT 306”.

In addition, the logical network control apparatus 103a includes a controller 307 that controls an input signal from an external input apparatus 308. The external input apparatus 308 such as a keyboard receives an operation by a user of the computer system performed thereon.

Moreover, the logical network control apparatus 103a includes a storage device 309 such as an HDD. The storage device 309 is used to store an application program and data such as image information, for example.

The application program according to the present exemplary embodiment is a software program constituting the exemplary embodiment of the present invention that implements the acquisition of information about the data length of a communication packet that can be transmitted via a logical connection (VPN connection) among networks without being divided.

Furthermore, the logical network control apparatus 103a includes an external input/output apparatus 310. For example, the external input/output apparatus 310 inputs and outputs a removable storage medium such as an FD or a CD-ROM. The external input/output apparatus 310 is used to read the above-described application program from the medium. The external input/output apparatus 310 is hereinafter also referred to as an “FDD 310”.

Note that an application program and data stored on the HDD 309 can be stored on the FDD 310, instead, to be read and used therefrom. Furthermore, the logical network control apparatus 103a includes an input/output bus (an address bus, a data bus and a control bus) 300 that mutually connects the above-described units of the logical network control apparatus 103a.

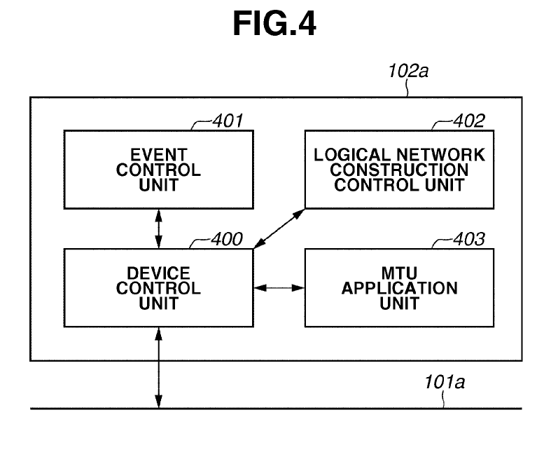

FIG. 4 illustrates an exemplary module configuration of the network-connected apparatus 102a according to the present exemplary embodiment. The network-connected apparatus 102a stores a program for executing the function of each module to be described below on the HDD 209 and reads and executes the program from the storage device (HDD) 209 with the CPU 201 to implement the function of the following units.

Referring to FIG. 4, a device control unit 400 controls the operation of the network-connected apparatus 102a. Furthermore, the device control unit 400 transmits and receives various messages to and from the logical network control apparatus 103a that connects the LAN 101a (the first network) to the VPN.

Furthermore, the device control unit 400 communicates with a network-connected apparatus on another network that has been connected to the VPN. An event control unit 401 issues a request for registering an event for notifying the MTU on the logical network control apparatus 103a.

Furthermore, the event control unit 401 receives the MTU notification event transmitted from the logical network control apparatus 103a.

A logical network construction control unit 402 issues a request for constructing or discontinuing a VPN connection to the logical network control apparatus 103a. An MTU application unit 403 applies the MTU with respect to Transmission Control Protocol/Internet Protocol (TCP/IP) processing performed by the network-connected apparatus 102a.

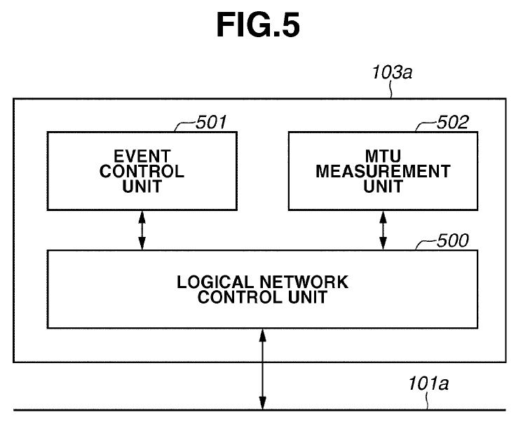

FIG. 5 illustrates an exemplary module configuration of the logical network control apparatus 103a according to the present exemplary embodiment. The logical network control apparatus 103a stores a program that executes the function of each module to be described below on the HDD 309 and reads and executes the program with the CPU 301 to implement the function of each module.

Referring to FIG. 5, a logical network control unit 500 transmits and receives various messages to and from the network-connected apparatus 102a connected to the LAN 101a (the first network).

Furthermore, the logical network control unit 500 implements the construction and the discontinuation of a VPN connection with another network according to a request from the network-connected apparatus 102a.

That is, the logical network control unit 500 relays the communication data received from the network-connected apparatus 102a on the LAN 101a (the first network) to a communication apparatus on another network via the logical connection (VPN).

Furthermore, the logical network control unit 500 stores a default MTU, which will be described in detail later below. In addition, the logical network control unit 500 acquires an optimum MTU from an MTU between apparatuses, which is an MTU applied to a communication with another network detected by an MTU measurement unit 502, which will be described in detail later below. The logical network control unit 500 stores the acquired MTU in an MTU list. Here, the “MTU between apparatuses” according to the present exemplary embodiment refers to the maximum data length of a communication packet that can be transmitted via the logical connection among logical network control apparatuses without being divided.

Furthermore, the optimum MTU refers to the data length calculated by subtracting the data length of information about the VPN, which is added to the communication data from the network-connected apparatus 102a by the logical network control apparatus 103a, from the MTU between apparatuses. The “information about the VPN” refers to information added to the communication data as a VPN header, for example.

That is, for example, if the network-connected apparatus 102a transmits a communication packet by applying the MTU between apparatuses and if the logical network control apparatus 103a adds a VPN header to the communication packet in this case, the data length of the communication packet may exceed (become greater than) the MTU between apparatuses.

Accordingly, the logical network control apparatus 103a calculates the optimum MTU by subtracting the data length of the information about the VPN from the MTU between apparatuses. Furthermore, the logical network control apparatus 103a notifies the resulting optimum MTU to the network-connected apparatus 102a.

That is, the logical network control unit 500 acquires information (the optimum MTU) corresponding to the data length (the MTU between apparatuses) of a communication packet that can be transmitted via the logical connection (VPN) without being divided.

The MTU list refers to a list including the connection destination of the logical network, the MTU between apparatuses, and a value of the optimum MTU. The MTU list will be described in detail later below.

An event control unit 501 performs processing for registering an MTU notification event according to a request from the network-connected apparatus 102a.

Furthermore, the event control unit 501 transmits the MTU notification event to the apparatus on which the MTU notification event has been registered.

The MTU measurement unit 502 detects the maximum data length (the MTU between apparatuses) of the communication packet that can be transmitted among logical network control apparatuses. That is, the MTU measurement unit 502 detects the data length of the communication packet that can be transmitted via the logical connection (VPN) without being divided.

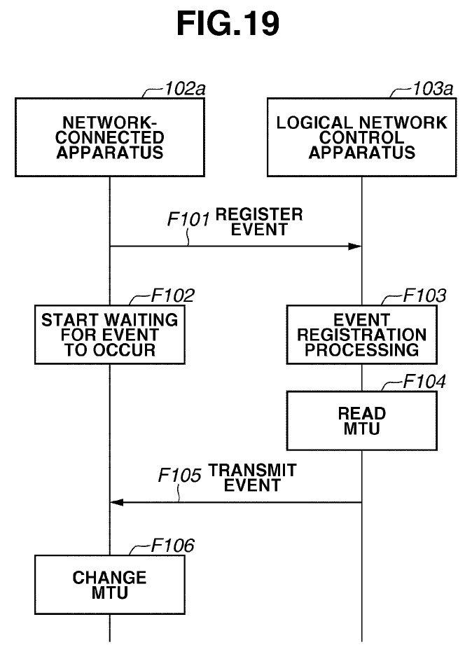

Now, a flow of processing for registering an MTU notification event performed by the network-connected apparatus 102a on the logical network control apparatus 103a will be described below with reference to FIG. 19. Note that the network-connected apparatus 102a is the communication apparatus on the LAN 101a (the first network).

Furthermore, the logical network control apparatus 103a is a relay apparatus connected to the LAN 101a (the first network) and logically connects the LAN 101a and another network so that the communication packet can be transmitted between the LAN 101a and another network.

Referring to FIG. 19, in step F101, the event control unit 401 of the network-connected apparatus 102a issues a request for registering the MTU notification event to the logical network control apparatus 103a.

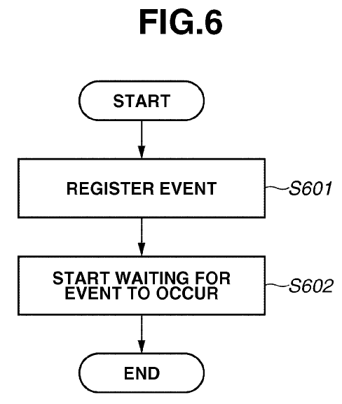

In step F102, the event control unit 401 of the network-connected apparatus 102a, which has transmitted the request for registering the event, starts waiting for the MTU notification event transmitted from the logical network control apparatus 103a. The processing performed related to a request for registering an MTU notification event performed by the network-connected apparatus 102a in step F101 and step F102 will be described in detail later below with reference to FIG. 6.

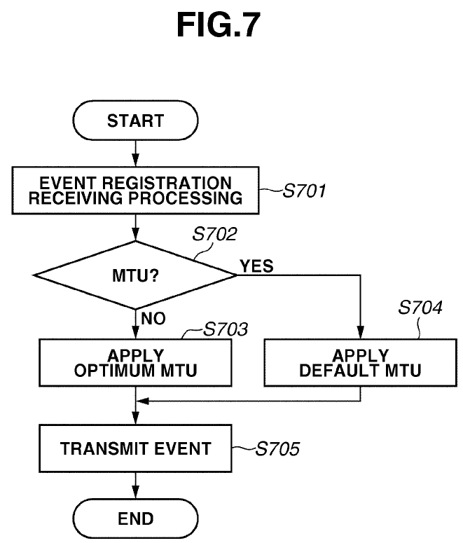

In step F103, the event control unit 501 of the logical network control apparatus 103a receives the request for registering the event from the network-connected apparatus 102a. Then, the event control unit 501 performs the processing for receiving the request for registering the event. In step F104, the event control unit 501 determines and reads the MTU to be notified to the network-connected apparatus 102a. The processing in steps F103 and F104 will described in detail later below with reference to FIG. 7.

In step F105, the event control unit 501 of the logical network control apparatus 103a transmits the MTU read in step F104 to the network-connected apparatus 102a on which the event has been registered.

After receiving the MTU notification event from the logical network control apparatus 103a by using the event control unit 401, the network-connected apparatus 102a performs processing for receiving the notification of the MTU.

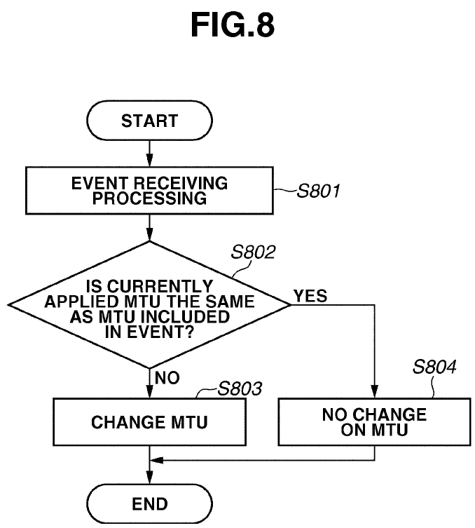

In step F106, the network-connected apparatus 102a changes the MTU with the MTU application unit 403 according to the notified MTU. The processing for receiving the MTU notification event will be described in detail later below with reference to FIG. 8.

Now, processing performed by the network-connected apparatus 102a related to a request for registering an event, which is performed as a part of processing for registering the MTU notification event, will be described in detail below with reference to FIG. 6. FIG. 6 is a flow chart that illustrates an example of a flow of processing for registering the MTU notification event performed by the network-connected apparatus 102a (the communication apparatus) on the LAN 101a (the first network) on the logical network control apparatus 103a (the relay apparatus).

Referring to FIG. 6, in step S601, the event control unit 401 of the network-connected apparatus 102a transmits a request for registering the MTU notification event to the logical network control apparatus 103a. Then, the processing advances to step S602.

Here, the present exemplary embodiment utilizes Universal Plug And Play (UPnP) for the MTU notification event. In the UPnP, processing for registering an event is equivalent to a “subscribe” request.

In step S602, the event control unit 401 performs processing for starting waiting for the MTU notification event. Then, the processing performed by the network-connected apparatus 102a related to a request for registering an event ends.

Now, processing for receiving a request for registering an event and processing for determining an MTU to be notified, which are performed by the logical network control apparatus 103a during processing for registering the MTU notification event, will be described in detail below with reference to FIG. 7. FIG. 7 is a flow chart that illustrates an example of a flow of processing for receiving a request for registering the MTU notification event and processing for determining the MTU to be notified performed by the logical network control apparatus 103a (the relay apparatus).

Referring to FIG. 7, in step S701, the event control unit 501 of the logical network control apparatus 103a performs processing for receiving a request for registering the MTU notification event transmitted from the network-connected apparatus 102a.

More specifically, in step S701, the event control unit 501 stores the address of the network-connected apparatus 102a, which is a transmission source of the request for registering the MTU notification event. Then, the processing advances to step S702.

In step S702, the logical network control unit 500 determines whether the MTU to be notified to the network-connected apparatus 102a is the same as the default MTU.

For example, in the case where the logical network control apparatus 103a has already started a VPN connection with another network and if the acquired MTU in the connection with another network is different from the default MTU, then the logical network control unit 500 determines that the MTU to be notified to the network-connected apparatus 102a differs from the default MTU.

Note that in the present exemplary embodiment, the default MTU between apparatuses is 1,500 bytes while the default optimum MTU is 1,450 bytes. As described above, the MTU between apparatuses refers to the maximum data length of a communication packet that can be transmitted among logical network control apparatuses without being divided.

Furthermore, the optimum MTU refers to the data length calculated by subtracting, from the MTU between apparatuses, the data length of the information about the VPN which the logical network control apparatus 103a adds to the communication data transmitted from the network-connected apparatus 102a. Note that in the present exemplary embodiment, the value of the default MTU between apparatuses is 1,500 bytes. However, the present exemplary embodiment is not limited to this. That is, the value of the default MTU between apparatuses can be arbitrarily and appropriately set.

Furthermore, the data length shorter than the maximum data length of a communication packet that can be transmitted among logical network control apparatuses can be used as the MTU between apparatuses.

If it is determined in step S702 that the MTU to be notified to the network-connected apparatus 102a is different from the default MTU (NO in step S702), then the processing advances to step S703. On the other hand, if it is determined in step S702 that the MTU to be notified to the network-connected apparatus 102a is the same as the default MTU (YES in step S702), then the processing advances to step S704.

In step S703, the event control unit 501 reads a smallest optimum MTU stored in the MTU list stored by the logical network control unit 500. Then, the processing advances to step S705.

In step S704, the event control unit 501 reads the default optimum MTU from the logical network control unit 500. Then, the processing advances to step S705.

In step S705, the event control unit 501 notifies the optimum MTU read in step S703 or step S704 to the network-connected apparatus 102a on which the MTU notification event has been registered in step S701. Then, the processing by the logical network control apparatus 103a ends.

Here, in step S705, the optimum MTU is notified to the network-connected apparatus 102a. However, the present exemplary embodiment is not limited to this. That is, it is also useful, for example, to notify the data length of the MTU between apparatuses and the information about the VPN to the network-connected apparatus 102a in step S705.

Now, processing for receiving an event performed by the network-connected apparatus 102a that has received the event from the logical network control apparatus 103a, which is performed as a part of processing for registering the MTU notification event, will be described in detail below with reference to FIG. 8. FIG. 8 is a flow chart that illustrates an example of a flow of processing for changing the MTU that is performed by the network-connected apparatus 102a (the communication apparatus) after receiving the MTU notification event.

Referring to FIG. 8, in step S801, the event control unit 401 of the network-connected apparatus 102a receives the MTU notification event transmitted from the logical network control apparatus 103a in step S705. Then, the processing advances to step S802.

In step S802, the MTU application unit 403 determines whether the MTU included in the event received in step S801 is the same as the MTU applied by using the MTU application unit 403.

If it is determined in step S802 that the MTU included in the event is different from the MTU applied by using the MTU application unit 403 (NO in step S802), then the processing advances to step S803. On the other hand, if it is determined in step S802 that the MTU included in the event is the same as the MTU applied by using the MTU application unit 403 (YES in step S802), then the processing advances to step S804.

In step S803, the MTU application unit 403 changes the MTU to be applied according to the MTU included in the MTU notification event. Then, the processing for receiving the MTU notification event ends.

In step S804, the MTU application unit 403 does not change the MTU to be applied and the processing for receiving the MTU notification event ends.

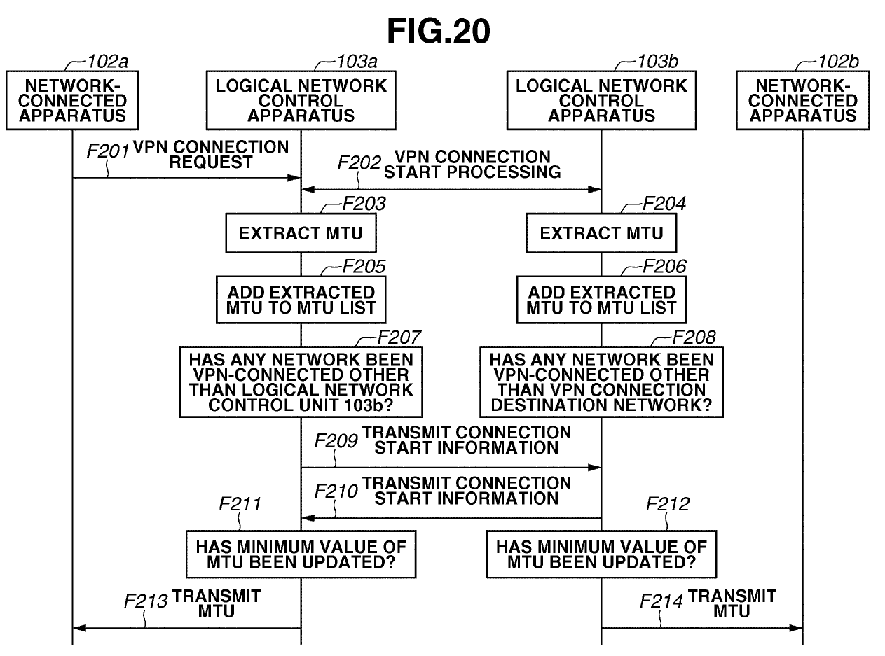

Now, an exemplary flow of VPN connection processing performed when the VPN connection between the logical network control apparatus 103a and the logical network control apparatus 103b is started will be described in detail below with reference to FIG. 20. Note that the network-connected apparatus 102a is the communication apparatus on the LAN 101a (the first network).

Furthermore, the logical network control apparatus 103a is a relay apparatus that is connected to the LAN 101a (the first network) and logically connects the LAN 101a and another network so that the communication packet can be transmitted between the LAN 101a and another network.

Moreover, the logical network control apparatus 103a relays the communication data received from the network-connected apparatus 102a (the communication apparatus) to the communication apparatus on another network via the logical connection (VPN) (relay processing). Furthermore, the logical network control apparatus 103b is the relay apparatus that connects the LAN 101b (another network) to the logical network (VPN).

In addition, it is supposed here that the network-connected apparatus 102a has already completed the processing for registering the event related to notifying the MTU to the logical network control apparatus 103a connected therewith performed via the connection with the logical network control apparatus 103a, which is described above with reference to FIGS. 6, 7, and 8. It is also supposed here that in the same way, the network-connected apparatus 102b has completed the processing for registering the event related to notifying the MTU to the logical network control apparatus 103b connected therewith performed via the communication with the logical network control apparatus 103b, which is described above with reference to FIGS. 6, 7, and 8.

Each of the network-connected apparatuses 102a and 102b has received, as described above, the notification of the default optimum MTU from the event control unit 501 of the corresponding logical network control apparatuses 103a or 103b in step S801 in FIG. 8. As described above, the default optimum MTU is 1,450 bytes in the present exemplary embodiment.

Referring to FIG. 20, in step F201, the logical network construction control unit 402 of the network-connected apparatus 102a transmits a request for constructing a VPN connection with the logical network control apparatus 103b to the logical network control unit 500 of the logical network control apparatus 103a. After receiving the VPN connection request transmitted from the logical network construction control unit 402 in step F201, the processing advances to step F202.

In step F202, the logical network control unit 500 of the logical network control apparatus 103a starts the VPN connection with the logical network control apparatus 103b. In step F203, the MTU measurement unit 502 of the logical network control apparatus 103a detects the MTU between apparatuses in the connection with the logical network control apparatus 103b.

Furthermore, the MTU measurement unit 502 of the logical network control apparatus 103a transmits the detected MTU between apparatuses to the logical network control unit 500.

More specifically, in step F203, the MTU measurement unit 502 detects the data length of a communication packet that can be transmitted via the logical connection (VPN) without being divided. As a method for detecting the MTU, a method can be used for transmitting an Internet Control Message Protocol (ICMP) packet, to which an instruction for inhibiting dividing the packet has been added.

Furthermore, in step F203, the logical network control unit 500 acquires the optimum MTU calculated by subtracting the data length of the information about the VPN from the transmitted MTU between apparatuses. In step F205, the logical network control unit 500 of the logical network control apparatus 103a adds, to the MTU list, an entry including a VPN connection destination, the MTU between apparatuses acquired in step F203, and the value of the optimum MTU. Note that the VPN connection destination is an address that provides an access to the logical network control apparatus 103b.

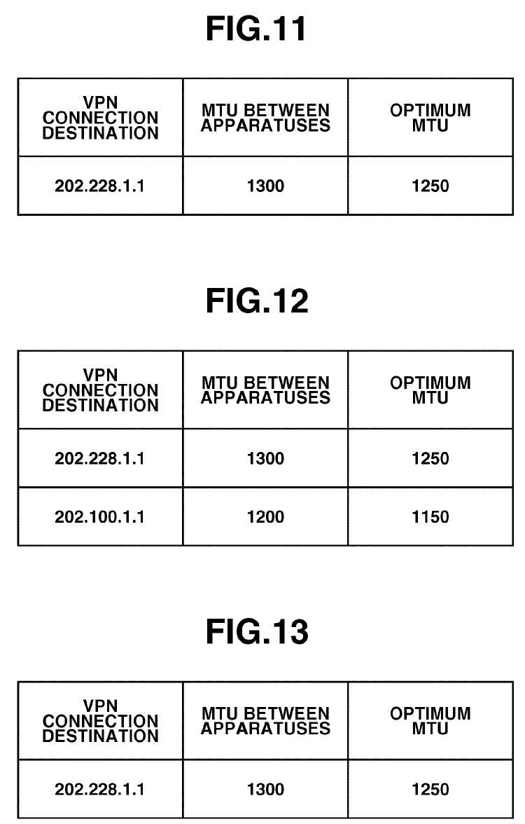

FIG. 11 illustrates an example of the MTU list that the logical network control unit 500 of the logical network control apparatus 103a stores in step F205. An Internet protocol (IP) address “202.228.1.1”, which is described in the MTU list, is the address that provides an access to the logical network control apparatus 103b.

In the present exemplary embodiment, the above-described IP address is the address of the router apparatus 104b, and a setting for DeMilitalized Zone (DMZ) and port forwarding is performed with respect to the router apparatus 104b. Thus, the router apparatus 104b can transfer the packet to the logical network control apparatus 103b.

The address illustrated in a VPN connection destination field in FIG. 11 is used in communicating with the logical network control apparatus 103b via the Internet. Note that the MTU detected among the logical network control apparatuses is 1,300 bytes, as illustrated in an MTU between apparatuses field in FIG. 11.

Furthermore, the optimum MTU is the data length that can be calculated by the following method. That is, the optimum MTU (the data length) can be calculated by subtracting the data length of the information about the VPN (50 bytes), which is to be added by the logical network control apparatuses 103a and 103b to the communication data transmitted from the network-connected apparatus 102, from the MTU between apparatuses (1,300 bytes).

As described above, the present exemplary embodiment stores the MTU between apparatuses and the optimum MTU in the MTU list. Accordingly, the present exemplary embodiment can notify a suitable optimum MTU even in the case where the data length to be subtracted from the MTU between apparatuses changes due to the change in the parameter that has occurred due to the connection of the logical network (VPN).

However, the information about the MTU to be stored in the MTU list in step S906 is not limited to the above-described information. That is, for example, it is also useful to use either one of the MTU between apparatuses and the optimum MTU and the data length of the information about the VPN.

In step F204, the logical network control apparatus 103b also acquires the optimum MTU by subtracting the data length of the information about the VPN from the MTU between apparatuses detected between the logical network control apparatus 103b and the logical network control apparatus 103a. With respect to the MTU between apparatuses, the logical network control apparatus 103b acquires the MTU between apparatuses detected by the logical network control apparatus 103a from the logical network control apparatus 103a.

Furthermore, it is also useful if the ICMP packet to which the instruction for inhibiting dividing the packet has been added is transmitted to the logical network control apparatus 103b so that the logical network control apparatus 103b can detect the MTU between apparatuses. In step F207, the logical network control unit 500 of the logical network control apparatus 103a determines whether the network that has already been VPN-connected exists other than the destination of the VPN connection constructed in step F202.

More specifically, the logical network control unit 500 refers to the MTU list and determines whether any network that the logical network control apparatus 103a has already been VPN-connected with exists other than the logical network control unit 103b.

If it is determined in step F207 that network that the logical network control apparatus 103a has already been VPN-connected with exists other than the logical network control unit 103b, then the processing advances to step F209. In step F209, the logical network control unit 500 transmits connection start information including the entry of the VPN connection destination to the logical network control apparatus 103b, which is the destination of the VPN connection that has been started in step F202.

In addition, in step F209, the logical network control unit 500 transmits the connection start information including the entry of the logical network control apparatus 103b to the logical network control apparatus that has already been VPN-connected. After receiving the connection start information, the logical network control apparatus adds the entry included in the received connection start information to the MTU list stored in the logical network control apparatus.

The entry added as described above can be utilized to notify the MTU to the network-connected apparatus. The entry includes information such as the VPN connection destination that has been connected before the logical network control apparatus 103a receives the VPN connection request in step F201. In addition, the entry includes the MTU between apparatuses and the optimum MTU in the VPN.

However, in this case, the logical network control apparatus 103a does not perform the notification in step F209 because the logical network control apparatus 103a has not been VPN-connected with an apparatus other than the logical network control apparatus 103b.

Furthermore, in step F208, the logical network control unit 500 of the logical network control apparatus 103b also determines whether any network that has already been VPN-connected exists other than the destination of the VPN connection constructed in step F202, as the logical network control apparatus 103a does. If it is determined in step F208 that a network that has already been VPN-connected exists other than the destination of the VPN connection constructed in step F202, then the processing advances to step F210. In step F210, the logical network control unit 500 of the logical network control apparatus 103b transmits the connection start information including the entry of the VPN connection destination to the logical network control apparatus 103a, which is the destination of the VPN connection that has been started in step F202.

After receiving the connection start information, the logical network control apparatus 103a adds the entry (the VPN connection destination, the MTU between apparatuses, and the optimum MTU) included in the received connection start information to the MTU list of the logical network control apparatus 103a. The entry added to the MTU list as described above can be utilized to notify the MTU to the network-connected apparatus 102a.

That is, the optimum MTU included in the entry added in step F210 can be considered in performing the determination of the minimum value of the optimum MTU in step F211, which will be described in detail below.

With the above-described configuration, the present exemplary embodiment can perform the communication by using the packet of the size determined according to the changed MTU when one logical network control apparatus constructs the VPN connection with a plurality of logical network control apparatuses.

Furthermore, in step F210, the logical network control unit 500 of the logical network control apparatus 103b transmits the connection start information including the entry of the logical network control apparatus 103a to the logical network control apparatus that has already been VPN-connected.

However, in the above-described example, the logical network control apparatus 103b has not been VPN-connected with an apparatus other than the logical network control apparatus 103a. Accordingly, the notification in step F210 is not performed.

In step F211, the logical network control unit 500 of the logical network control apparatus 103a determines whether the minimum value of the optimum MTU stored in the MTU list has been changed.

More specifically, the logical network control unit 500 compares the MTU (predetermined information) that has been notified as the event so far and the optimum MTU acquired in step F203. If it is determined in step F211 that the minimum value of the optimum MTU has been changed, then the logical network control unit 500 reads the changed minimum value of the optimum MTU. In the example illustrated in FIG. 20, no other optimum MTU has been stored in the MTU list. Accordingly, the logical network control unit 500 determines that the minimum value has been changed to the optimum MTU (1,250 bytes) acquired in step F203.

In step F211, the logical network control unit 500 refers to the MTU list and acquires the optimum MTU in the connection with the logical network control apparatus 103b, which has been newly set as the minimum value of the optimum MTU.

More specifically, the logical network control unit 500 acquires information (the optimum MTU) about the data length that has been detected by the MTU measurement unit 502 according to a change of the status of the logical connection of another network (the LAN 101b).

Then, the logical network control unit 500 issues, to the event control unit 501, a request for transmitting the event for notifying the changed MTU. In step F213, the event control unit 501 transmits the event for notifying the MTU read in step F211 to the network-connected apparatus 102a on which the MTU notification event has been registered.

More specifically, the event control unit 501 notifies, to the network-connected apparatus 102a on the LAN 101a (the first network), information (the optimum MTU) about the data length of a communication packet that can be transmitted via the logical connection without being divided (VPN), which has been acquired in step F211. Note that in the present exemplary embodiment, if it is determined in step F211 that the minimum value of the optimum MTU has not been changed, then the event control unit 501 does not transmit the event in step F213.

The network-connected apparatus 102a receives the MTU notification event with the event control unit 401 and changes the MTU to be applied with the MTU application unit 403.

In step F212, the logical network control unit 500 of the logical network control apparatus 103b also determines whether the minimum value of the optimum MTU stored in the MTU list has been changed as the logical network control apparatus 103a does.

More specifically, the logical network control unit 500 compares the MTU (predetermined information) that has been notified as the event so far and the optimum MTU acquired in step F204 to determine whether the minimum value of the optimum MTU has been changed.

If it is determined in step F212 that the minimum value of the optimum MTU has been changed, then the logical network control unit 500 reads the changed minimum value of the optimum MTU.

In the example illustrated in FIG. 20, no other optimum MTU has been stored in the MTU list. Accordingly, the logical network control unit 500 determines that the minimum value has been changed to the optimum MTU (1,250 bytes) acquired in step F204. In step F214, the event control unit 501 transmits the event for notifying the MTU read in step F212 to the network-connected apparatus 102b on which the MTU notification event has been registered.

Note that if it is determined in step F212 that the minimum value of the optimum MTU has not been changed, then the event control unit 501 does not transmit the event in step F214. Then, the network-connected apparatus 102b receives the MTU notification event with the event control unit 401 and changes the MTU to be applied with the MTU application unit 403.

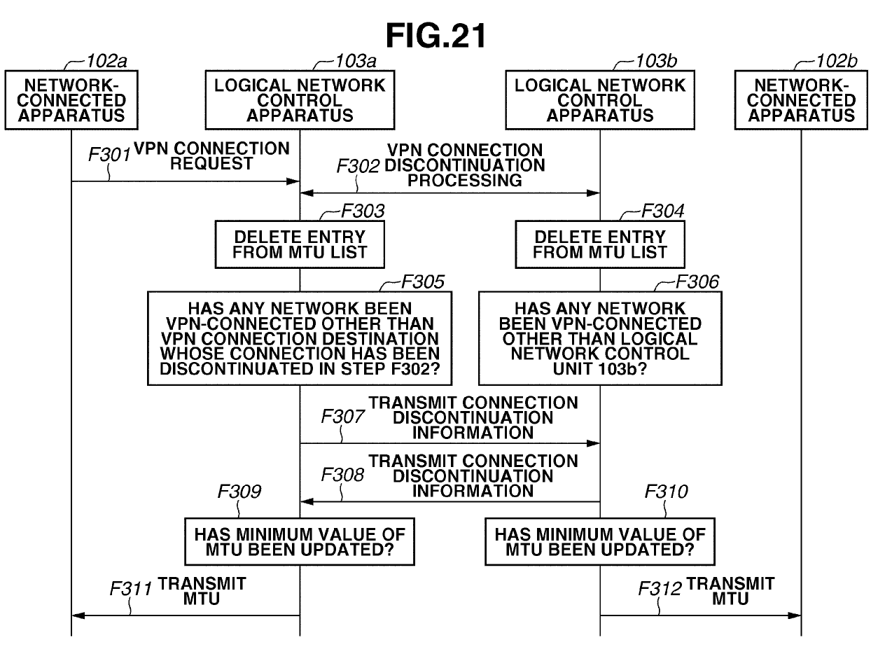

Now, a flow of VPN discontinuation processing performed in the case of discontinuing the VPN connection between the logical network control apparatus 103a and the logical network control apparatus 103b will be described in detail below with reference to FIG. 21.

Note that before starting the processing illustrated in FIG. 21, each of the logical network control apparatus 103a and the logical network control apparatus 103b has already performed the processing described above with reference to FIG. 20 to start the VPN connection.

Each of the network-connected apparatuses 102a and 102b has received, as described above, the notification of the optimum MTU (1,250 bytes) from the event control unit 501 of the corresponding logical network control apparatus 103a or 103b in the VPN connection processing (steps F213 and F214).

Furthermore, it is supposed here that the network-connected apparatus 102a has completed the processing for registering the event related to notifying the MTU to the logical network control apparatus 103a connected therewith, which is described above with reference to FIGS. 6, 7, and 8. It is also supposed here that in the same way, the network-connected apparatus 102b has completed the processing for registering the MTU notification event performed to the logical network control apparatus 103b connected therewith, which is described above with reference to FIGS. 6, 7, and 8.

Referring to FIG. 21, in step F301, the logical network construction control unit 402 of the network-connected apparatus 102a transmits the request for discontinuing the VPN connection with the logical network control apparatus 103b to the logical network control unit 500 of the logical network control apparatus 103a.

After receiving the request for discontinuing the VPN connection transmitted in step F301, the processing advances to step F302. In step F302, the logical network control unit 500 of the logical network control apparatus 103a discontinues the VPN connection with the logical network control apparatus 103b.

In step F303, the logical network control unit 500 of the logical network control apparatus 103a deletes the entry of the logical network control apparatus 103b stored in the MTU list.

In step F304, the logical network control unit 500 of the logical network control apparatus 103b, in the same way, deletes the entry of the logical network control apparatus 103a stored in the MTU list.

In step F305, the logical network control unit 500 of the logical network control apparatus 103a determines whether a network that has been VPN-connected exists other than the destination of the VPN connection discontinued in step F302.

More specifically, the logical network control unit 500 refers to the MTU list and determines whether a network in which the logical network control apparatus 103a is VPN-connected exists other than the logical network control unit 103b. If it is determined in step F305 that a network in which the logical network control apparatus 103a is VPN-connected exists other than the logical network control unit 103b, then the processing advances to step F307.

In step F307, the logical network control unit 500 transmits, to the currently connected VPN connection destination, connection discontinuation information indicating that the connection with the logical network control apparatus 103b has been discontinued. The connection discontinuation information includes information about the destination of the VPN connection that has been discontinued in step F302, the MTU between apparatuses in the VPN connection, and information about the optimum MTU.

After receiving the connection discontinuation information, the logical network control apparatus 103b searches for the entry of the logical network control apparatus 103b from the information about the VPN connection destination included in the received connection discontinuation information and deletes the entry of the logical network control apparatus 103b extracted as a result of the search. Then, the result of the processing can be utilized in notifying the MTU to the network-connected apparatus 102b.

Furthermore, in step F307, the logical network control unit 500 transmits, to the logical network control apparatus 103b, the connection discontinuation information indicating that the connection with another network determined to have been VPN-connected in step F305 is currently discontinued.

The connection discontinuation information includes the connection destination of another VPN (the VPN other than the VPN with the logical network control apparatus 103b) to which the logical network control apparatus 103a is connected and the MTU between apparatuses and the optimum MTU in the VPN.

After receiving the connection discontinuation information, the logical network control apparatus 103b searches for the entry in the MTU list based on the information about the VPN connection destination included in the received connection discontinuation information and deletes the entry extracted as a result of the search. The result of this can be utilized in notifying the MTU to the network-connected apparatus 102b.

However, in the example illustrated in FIG. 21, the logical network control apparatus 103a does not perform the notification in step F307 because the logical network control apparatus 103a has not been VPN-connected with an apparatus other than the logical network control apparatus 103b.

Furthermore, in step F306, as the logical network control unit 500 of the logical network control apparatus 103a does, the logical network control unit 500 of the logical network control apparatus 103b also determines whether a network that has been VPN-connected exists other than the destination of the VPN connection that has been discontinued in step F302.

More specifically, the logical network control unit 500 of the logical network control apparatus 103b determines whether a VPN-connected network exists other than the logical network control apparatus 103a.

If it is determined in step F306 that a VPN-connected network exists other than the logical network control apparatus 103a, then the processing advances to step F308. In step F308, the logical network control unit 500 of the logical network control apparatus 103b transmits, to the currently connected VPN connection destination, connection discontinuation information indicating that the connection with the logical network control apparatus 103a has been discontinued.

In addition, in step F308, the logical network control unit 500 transmits, to the logical network control apparatus 103a, the connection discontinuation information indicating that the connection with another network determined to have been VPN-connected in step F306 is currently discontinued.

Note, as described above, that the connection discontinuation information includes information about another VPN connection destination whose VPN connection has been discontinued. After receiving the connection discontinuation information, the logical network control apparatus 103a searches for the entry in the MTU list based on the information about another VPN connection destination included in the received connection discontinuation information. The result of the search can be utilized to notify the MTU to the network-connected apparatus 102a.

That is, it can be considered that the entry has been deleted in step F308 at the time of determining the minimum value of the optimum MTU in step F309. The processing in step F309 will be described in detail later below.

With the above-described configuration, the present exemplary embodiment can perform the communication by using a packet of the size determined according to the changed MTU when one logical network control apparatus performs the VPN connection to a plurality of logical network control apparatuses.

However, in the example illustrated in FIG. 21, the logical network control apparatus 103b does not perform the notification in step F307 because the logical network control apparatus 103b has not been VPN-connected with an apparatus other than the logical network control apparatus 103a.

In step F309, the logical network control unit 500 of the logical network control apparatus 103a determines whether the minimum value of the optimum MTU stored in the MTU list has been changed. If it is determined in step F309 that the minimum value of the optimum MTU has been changed, then the logical network control unit 500 of the logical network control apparatus 103a reads the changed minimum value of the optimum MTU.

More specifically, the logical network control unit 500 performs the following processing when the status of the logical connection of another network (the LAN 101b) has been changed.

That is, the logical network control unit 500 acquires information about the data length of a communication packet that can be transmitted via the logical connection without being divided, which is detected by the MTU measurement unit 502.

However, in the example illustrated in FIG. 21, all the VPN connections are discontinued. Accordingly, the logical network control unit 500 does not acquire the information in step F309. In step F311, the logical network control unit 500 notifies the read optimum MTU to the network-connected apparatus 102a.

More specifically, the event control unit 501 notifies, to the communication apparatus (the network-connected apparatus 102a) on the LAN 101a (the first network), information about the data length of a communication packet that can be transmitted via the logical connection (VPN) without being divided acquired in step F309.

However, in the example illustrated in FIG. 21, all the VPN connections are discontinued. Accordingly, the logical network control unit 500 does not perform the processing in step F311.

In step F310, the logical network control unit 500 of the logical network control apparatus 103b determines whether the minimum value of the optimum MTU stored in the MTU list has been changed, as the logical network control apparatus 103a does.

If it is determined in step F310 that the minimum value of the optimum MTU has been changed, then the logical network control unit 500 reads the changed minimum value. Instep F312, the logical network control unit 500 notifies the optimum MTU to the network-connected apparatus 102a.

However, in the example illustrated in FIG. 21, the VPN connections with all the networks are discontinued. Accordingly, the logical network control unit 500 does not perform the processing in steps F310 and F312.

Now, processing performed by the logical network control apparatus 103a for starting a VPN connection between the logical network control apparatus 103a and the logical network control apparatus 103b will be described in detail below.

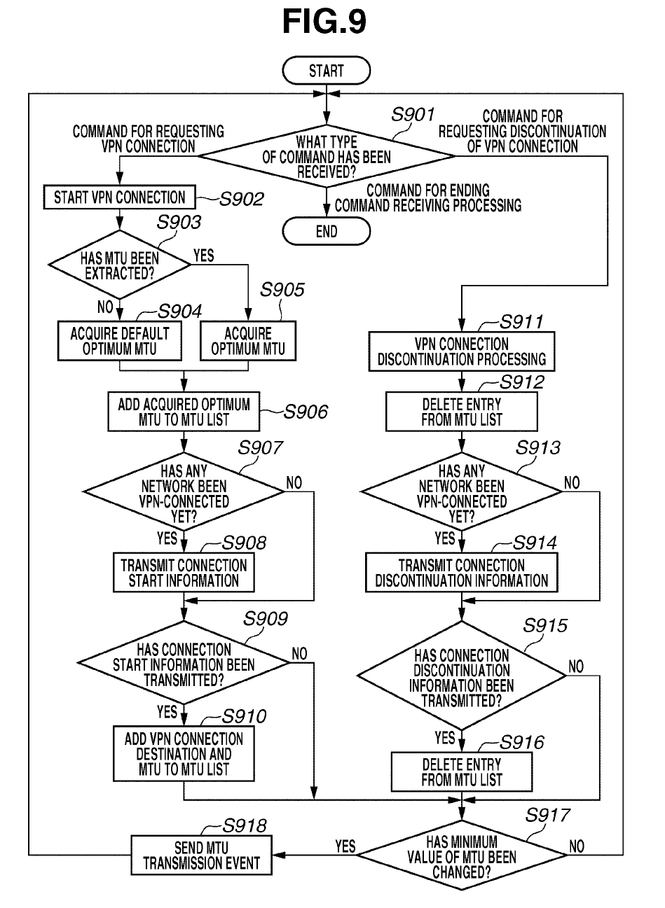

FIG. 9 is a flow chart that illustrates an example of a flow of receiving processing performed when the logical network control apparatus 103a has received an instruction for starting or discontinuing a VPN connection from the network-connected apparatus 102a (the communication apparatus).

Note that it is supposed here that the network-connected apparatus 102a (the communication apparatus) has completed the processing for registering the event related to notifying the MTU to the logical network control apparatus 103a connected therewith, which is described above with reference to FIGS. 6, 7, and 8. It is also supposed here that in the same way, the network-connected apparatus 102b (the communication apparatus) has completed the processing for registering the event related to notifying the MTU to the logical network control apparatus 103b connected therewith, which is described above with reference to FIGS. 6, 7, and 8.

Each of the network-connected apparatuses 102a and 102b has received, as described above, the notification of the default optimum MTU from the event control unit 501 of the corresponding logical network control apparatus 103a or 103b in step S801 in FIG. 8. As described above, the default optimum MTU is 1,450 bytes in the present exemplary embodiment.

Furthermore, the logical network control apparatus 103a relays the communication data received from the network-connected apparatus 102a (the communication apparatus) to the communication apparatus on another network via the logical connection (VPN) (the relay processing).

In step S901 in FIG. 9, the logical network control unit 500 of the logical network control apparatus 103a receives a VPN connection request for starting a VPN connection with another network or a VPN discontinuation request for discontinuing a VPN connection with another network from the network-connected apparatus 102a. More specifically, in step S901, the logical network control unit 500 of the logical network control apparatus 103a determines which of the VPN connection request or the VPN discontinuation request has been received.

If it is determined in step S901 that the logical network control unit 500 has received the VPN connection request, then the processing advances to step S902. On the other hand, if it is determined in step S901 that the logical network control unit 500 has received the VPN discontinuation request, then the processing advances to step S911.

Note that if the logical network control unit 500 receives an instruction for ending the processing for receiving the request related to the VPN connection from a management application installed in the logical network control apparatus 103a in step S901, then the processing for receiving the request related to the VPN connection ends.

Furthermore, the VPN connection or discontinuation request received in step S901 includes address information for identifying the network that is the destination of the VPN connection. Note that it is supposed here that the VPN connection request including the address information for identifying the logical network control apparatus 103b has been received in step S901.

In step S902, the logical network control unit 500 starts the VPN connection with the logical network control apparatus 103b, which is the VPN connection destination, according to the address information included in the received VPN connection request. Then, the processing advances to step S903.

In step S903 (detection processing), the logical network control unit 500 issues, to the MTU measurement unit 502, a request for detecting the MTU between apparatuses in the connection between the logical network control apparatus 103a and the logical network control apparatus 103b, which is the VPN connection destination. The MTU measurement unit 502 detects the MTU between apparatuses in the connection between the logical network control apparatus 103a and the logical network control apparatus 103b according to the request.

More specifically, the MTU measurement unit 502 detects the data length of a communication packet that can be transmitted via the logical connection (VPN) without being divided. For example, as a method for detecting the MTU, a method for transmitting an ICMP packet, to which an instruction for inhibiting dividing the packet has been added, can be used. If the MTU measurement unit 502 cannot detect an MTU in step S903 (NO in step S903), then the processing advances to step S904.

On the other hand, if the MTU measurement unit 502 has detected the MTU (YES in step S903), then the MTU measurement unit 502 transmits the detected MTU between apparatuses to the logical network control apparatus 500. Then, the processing advances to step S905.

In step S904, the MTU measurement unit 502 reads a previously stored default MTU between apparatuses and transmits the read default MTU between apparatuses to the logical network control unit 500.

In step S904, the logical network control unit 500 refers to the transmitted default MTU between apparatuses and acquires therefrom the optimum MTU, which is calculated by subtracting the data length of the information about the VPN added by the logical network control apparatus 103. Then, the processing advances to step S906.

As described above, the present exemplary embodiment calculates the optimum MTU in step S904. Thus, the present exemplary embodiment can notify an optimum MTU suitable as a parameter for the logical connection of the network (VPN). However, the present exemplary embodiment is not limited to this. That is, it is also useful to previously subtract the data length of the information about the VPN from the default MTU and to store the resulting default MTU.

In step S905, the logical network control unit 500 refers to the transmitted MTU between apparatuses and acquires therefrom the optimum MTU calculated by subtracting the data length of the information about the VPN added by the logical network control apparatus 103. Then, the processing advances to step S906.

In the example illustrated in FIG. 9, it is supposed that the MTU between apparatuses (1,300 bytes) has been detected in the connection with the logical network control apparatus 103b in step S903. Accordingly, the acquired optimum MTU is 1,250 bytes.

In step S906, the logical network control unit 500 adds the entry (the address of the transmission destination (the address that provides an access to the logical network control apparatus 103b), the MTU between apparatuses, and the optimum MTU) of the logical network control apparatus 103b to the MTU list. Then, the processing advances to step S907.

FIG. 11 illustrates an example of the MTU list that the logical network control unit 500 of the logical network control apparatus 103a stores. The IP address “202.228.1.1”, which is stored in the MTU list, includes the address that provides an access to the logical network control apparatus 103b.

In the present exemplary embodiment, the IP address “202.228.1.1” is the address of the router apparatus 104b, and a setting for DeMilitalized Zone (DMZ) and port forwarding is performed with respect to the router apparatus 104b.

Accordingly, the router apparatus 104b can transfer a packet to the logical network control apparatus 103b. The address illustrated in a VPN connection destination field in FIG. 11 is used in communicating with the logical network control apparatus 103b via the Internet.

Furthermore, the MTU detected between the logical network control apparatuses 103a and 103b is 1,300 bytes, as indicated in an MTU between apparatuses field. The optimum MTU is the data length calculated by the following method. That is, the optimum MTU (the data length) can be calculated by subtracting the data length (50 bytes) related to the VPN, which is added to the communication data transmitted and received between the logical network control apparatus 103a and the logical network control apparatus 103b from the MTU between apparatuses (1,300 bytes).

As described above, the present exemplary embodiment stores the MTU between apparatuses and the optimum MTU in the MTU list. Accordingly, the present exemplary embodiment can notify the suitable optimum MTU even if the parameter related to the logical connection of the network (VPN) is changed.

However, the information related to the MTU to be stored in the MTU list in step S906 is not limited to the above-described information. That is, for example, it is also useful to use the data length of either one of the MTU between apparatuses and the optimum MTU and the information about the VPN.

In step S907, the logical network control unit 500 of the logical network control apparatus 103a determines whether a network that has already been VPN-connected exists other than the destination of the VPN connection that has been started in step S902.

More specifically, the logical network control unit 500 refers to the MTU list and determines whether a network that has been VPN-connected exists other than the logical network control apparatus 103b.

If it is determined in step S907 that a network that has been VPN-connected exists other than the logical network control apparatus 103b (YES in step S907), then the processing advances to step S908. On the other hand, if it is determined in step S907 that any network that has been VPN-connected other than the logical network control apparatus 103b does not exist (NO in step S907), then the processing advances to step S909.

In step S908, the logical network control unit 500 transmits, to the logical network control apparatus 103b that has started the VPN connection in step S902, the connection start information including the entry of the logical network control apparatus on the network that has already been VPN-connected. The entry includes information such as the VPN connection destination that has been VPN-connected before the logical network control apparatus 103a starts the VPN connection in step S902. In addition, the entry includes the MTU between apparatuses and the optimum MTU in the VPN.

Furthermore, the logical network control unit 500 transmits, to the logical network control apparatus on the network that has already been VPN-connected, the connection start information including the entry of the logical network control apparatus 103b that has started the VPN connection in step S902. Then, the processing advances to step S909.

The entry includes information such as the VPN connection destination to which the logical network control apparatus 103a has started the VPN connection in step S902. In addition, the entry includes the MTU between apparatuses and the optimum MTU in the VPN. After receiving the connection start information, the logical network control apparatus adds the entry (the VPN connection destination, the MTU between apparatuses, and the optimum MTU) included in the received connection start information to the MTU list stored in the logical network control apparatus. The added entry can be used in notifying the MTU to the network-connected apparatus.

That is, the optimum MTU included in the added entry can be considered in determining the minimum value of the optimum MTU. With the above-described configuration, the present exemplary embodiment can perform the communication by using a packet of the size determined according to the changed MTU when one logical network control apparatus performs the VPN connection to a plurality of logical network control apparatuses.

However, in the example illustrated in FIG. 9, the logical network control apparatus 103a has not been VPN-connected with an apparatus other than the logical network control apparatus 103b. Accordingly, the logical network control unit 500 does not perform the notification in step S908.

In step S909, the logical network control unit 500 of the logical network control apparatus 103a determines whether the connection start information has been transmitted from the logical network control apparatus 103b.

If it is determined in step S909 that the connection start information has been transmitted from the logical network control apparatus 103b (YES in step S909), then the processing advances to step S910. On the other hand, if it is determined in step S909 that the connection start information has not been transmitted from the logical network control apparatus 103b (NO in step S909), then the processing advances to step S917.

Note that the connection start information includes the VPN connection destination that has been VPN-connected before the logical network control apparatus 103b starts the VPN connection with the logical network control apparatus 103a and information about the MTU between apparatuses and the optimum MTU in the VPN.

In step S910, the logical network control unit 500 of the logical network control apparatus 103a adds the VPN connection destination, the MTU between apparatuses, and the optimum MTU included in the received connection start information to the MTU list.

Here, the VPN connection destination includes the address that provides an access to the logical network control apparatus. Furthermore, the logical network control apparatus 103a can utilize the added entry in notifying the MTU to the network-connected apparatus. That is, the optimum MTU included in the entry added in step S910 can be considered in determining the minimum value of the optimum MTU in step S917. Here, the processing in step S917 will be described in detail later below.

With the above-described configuration, the present exemplary embodiment can perform the communication by using a packet of the size determined according to the changed MTU when one logical network control apparatus performs the VPN connection with a plurality of logical network control apparatuses.

However, in the example illustrated in FIG. 9, the logical network control apparatus 103b has not been VPN-connected with an apparatus other than the logical network control apparatus 103a. Accordingly, the logical network control unit 500 does not perform the processing in step S910.

On the other hand, if the logical network control apparatus 103a receives a request for discontinuing the VPN connection with the logical network control apparatus 103b from the network-connected apparatus 102a in step S901, then the processing advances to step S911.

In step S911, the logical network control unit 500 performs the processing for discontinuing the VPN connection with the logical network control apparatus 103b that has been VPN-connected according to the address information included in the request for discontinuing the received VPN connection the received VPN connection. Then, the processing advances to step S912.

In step S912, the logical network control unit 500 searches the MTU list for the entry on which the processing for discontinuing the VPN connection has been performed. Then, the logical network control unit 500 deletes the entry extracted as a result of the search from the MTU list. Then, the processing advances to step S913. In the example illustrated in FIG. 9, the logical network control unit 500 deletes the entry of the logical network control apparatus 103b.

In step S913, the logical network control unit 500 determines whether a network that has been VPN-connected exists other than the destination of the VPN connection discontinued in step S911.

More specifically, the logical network control unit 500 refers to the MTU list and determines whether a network that has been VPN-connected exists other than the logical network control apparatus 103b.

If it is determined in step S913 that a network that has been VPN-connected exists other than the logical network control apparatus 103b (YES in step S913), then the processing advances to step S914. On the other hand, if it is determined in step S913 that any network that has been VPN-connected does not exist other than the logical network control apparatus 103b (NO in step S913), then the processing advances to step S915.

In step S914, the logical network control unit 500 transmits the connection discontinuation information indicating that the VPN connection with the logical network control apparatus 103b has been discontinued to the logical network control apparatus, which is the VPN connection destination extracted in step S913.

The connection discontinuation information includes the VPN connection destination (the address that provides an access to the logical network control apparatus 103b) whose VPN connection has been discontinued in step F912 and information about the MTU between apparatuses and the optimum MTU in the VPN.

After receiving the connection discontinuation information, the logical network control apparatus searches for the entry of the logical network control apparatus 103b based on the information about the VPN connection destination included in the received connection discontinuation information and deletes the entry extracted as a result of the search. The result of the search can be utilized in notifying the MTU to the network-connected apparatus.

Furthermore, in step S914, the logical network control unit 500 transmits, to the logical network control apparatus 103b, the connection discontinuation information indicating that the VPN connection with the logical network control apparatus, which is the VPN connection destination extracted in step S913, has been discontinued. Then, the processing advances to step S915.

The connection discontinuation information includes the connection destination of the VPN (the VPN other than the VPN with the logical network control apparatus 103b) by the logical network control apparatus 103a and information about the MTU between apparatuses and the optimum MTU in the VPN.

After receiving the connection discontinuation information, the logical network control apparatus 103b searches for the entry in the MTU list based on the information about the VPN connection destination included in the received connection discontinuation information and deletes the entry extracted as a result of the search. The result of the search can be utilized in notifying the MTU to the network-connected apparatus 102b.

However, in the example illustrated in FIG. 9, the logical network control apparatus 103a has not been VPN-connected with an apparatus other than the logical network control apparatus 103b. Accordingly, the logical network control unit 500 does not perform the processing in step S914.

In step S915, the logical network control unit 500 of the logical network control apparatus 103a determines whether the connection discontinuation information has been transmitted from the logical network control apparatus 103b whose VPN connection has been discontinued in step S912.

If it is determined in step S915 that the connection discontinuation information has been transmitted from the logical network control apparatus 103b (YES in step S915), then the processing advances to step S916. On the other hand, if it is determined in step S915 that the connection discontinuation information has not been transmitted from the logical network control apparatus 103b (NO in step S915), then the processing advances to step S917.

Note that the connection discontinuation information includes the connection destination of the VPN (the VPN other than the VPN with the logical network control apparatus 103a) by the logical network control apparatus 103b and information about the MTU between apparatuses and the optimum MTU in the VPN.

After receiving the connection discontinuation information in step S915, the processing advances to step S916. In step S916, the logical network control apparatus 103a searches for the entry in the MTU list based on the VPN connection destination included in the connection discontinuation information and deletes the entry extracted as a result of the search. The result of the search can be utilized in notifying the MTU to the network-connected apparatus 102a.

That is, it can be considered that the entry has been deleted in step S916 in determining the minimum value of the optimum MTU in step S917, which will be described in detail later below. With the above-described configuration, the present exemplary embodiment can perform a communication by using a packet of the size determined according to the changed MTU when one logical network control apparatus performs the VPN connection with a plurality of logical network control apparatuses.

However, in the present exemplary embodiment, the logical network control apparatus 103a discontinues all the VPN connections. Accordingly, the logical network control unit 500 does not perform the processing in step S916.

Furthermore, in this case, it is also useful not to perform the determination in step S915.

In step S917 (acquisition processing), the logical network control unit 500 determines whether the minimum value of the optimum MTU stored in the MTU list has been changed. If it is determined in step S917 that the minimum value of the optimum MTU has been changed (YES in step S917), then the logical network control unit 500 reads the changed minimum value of the optimum MTU. Then, the processing advances to step S918.

More specifically, the logical network control unit 500 acquires information (the optimum MTU) coresponding to the data length of the changed communication packet that has been detected by the MTU measurement unit 502 when the status of the logical connection of another network (the LAN 101b) is changed.

However, in the present exemplary embodiment, the logical network control apparatus 103a has not performed the VPN connection. Accordingly, the logical network control unit 500 does not perform the processing in step S917.

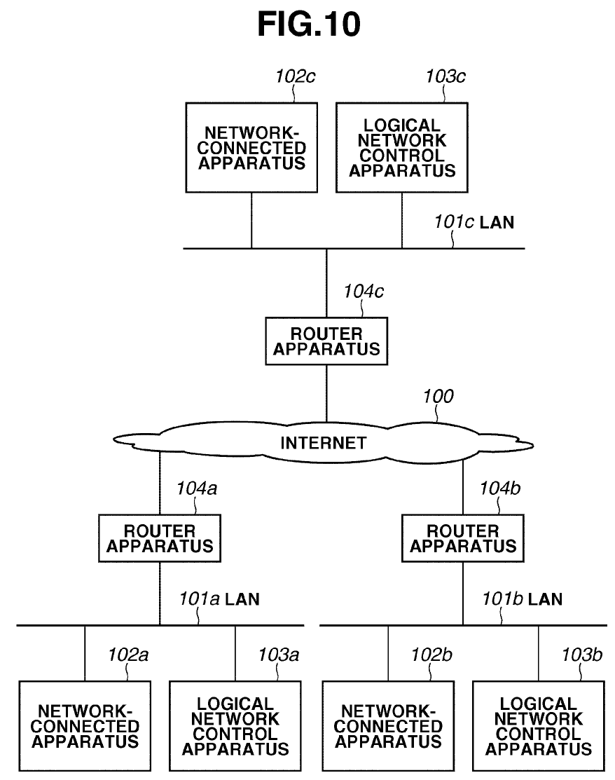

A second exemplary embodiment of the present invention will now be described below with reference to drawings focusing on points of difference from the first exemplary embodiment. FIG. 10 illustrates an example of a configuration of the network system according to the second exemplary embodiment of the present invention. The network system includes a LAN 101c. Here, note that the LAN 101c is not limited to a LAN. That is, a WAN or an ad hoc network (or a combination thereof) can be used as the LAN 101c.

The LAN 101c (another network) is a network having the same function as those of the LAN 101a (the first network) and the LAN 101b (another network). A network-connected apparatus 102c is connected to the LAN 101c (another network) and performs a communication via the network using a communication application. In the present exemplary embodiment, the network-connected apparatus 102a, the network-connected apparatus 102b, and the network-connected apparatus 102c are the communication apparatuses having similar functions.

A logical network control apparatus 103c is connected to the LAN 101c (another network) and constructs a VPN connection according to a request from the network-connected apparatus 102c.

More specifically, the logical network control apparatus 10c connects the LAN 101c (another network) to the logical network (VPN). In the present exemplary embodiment, the logical network control apparatus 103a, the logical network control apparatus 103b, and the logical network control apparatus 103c are the relay apparatuses having similar functions.

A router apparatus 104c is connected to each of the Internet 100 and the LAN 101c and controls a path for a packet. In the present exemplary embodiment, the router apparatus 104a, the router apparatus 104b, and the router apparatus 104c are the network apparatuses having similar functions.

In the present exemplary embodiment, to begin with, processing performed in the case where the logical network control apparatus 103a, which has been VPN-connected with the logical network control apparatus 103b in the manner described above in the first exemplary embodiment, further VPN-connects with the logical network control apparatus 103c is described.

Note that the logical network control apparatus 103a is a relay apparatus that is connected to the LAN 101a (the first network) and logically connects the LAN 101a and another network so that a communication packet can be transmitted between the LAN 101a and another network.

The logical network control apparatus 103a relays the communication data received from the network-connected apparatus 102a (the communication apparatus) on the LAN 101a (the first network) to the communication apparatus on another network via the logical connection (VPN) (the relay processing).

Furthermore, each of the logical network control apparatuses 103b and 103c is the relay apparatus that connects the LAN 101b and the LAN 101c (another network) to the logical network (VPN).

In the present exemplary embodiment, it is supposed that the network-connected apparatus 102a has completed the processing for registering the event related to notifying the MTU to the logical network control apparatus 103a connected therewith, which is described with reference to FIGS. 6, 7, and 8. It is also supposed here that in the same way, each of the network-connected apparatuses 102b and 102c has completed the processing for registering the event related to notifying the MTU to the respectively corresponding logical network control apparatuses 103b and 103c connected therewith, which is described with reference to FIGS. 6, 7, and 8.

The network-connected apparatus 102c receives the notification of the default optimum MTU from the event control unit 501 of the logical network control apparatus 103c in step S801 in FIG. 8. In the present exemplary embodiment, the default optimum MTU is 1,450 bytes.

Note that in the present exemplary embodiment, the type of the logical network is not limited to a specific type. Accordingly, the data length of a header added for a communication by the logical network can be arbitrarily determined. In the present exemplary embodiment, the data length of information added with respect to the VPN communication is 50 bytes. However, the present exemplary embodiment is not limited to this. That is, arbitrarily determined various data lengths can be used.

In addition, in the present exemplary embodiment, it is supposed that the logical network control apparatus 103a has already started the VPN connection with the logical network control apparatus 103b. FIG. 11 illustrates an example of an MTU list stored by the logical network control unit 500 of the logical network control apparatus 103a.

Referring to FIG. 11, the MTU detected between the logical network control apparatuses 103a and 103b is 1,300 bytes as illustrated by an MTU between apparatuses field, as described above. Furthermore, the optimum MTU (the data length (1,250 bytes)) can be calculated by subtracting the data length (50 bytes) related to the VPN, which is added to the communication data transmitted and received between the logical network control apparatus 103a and the logical network control apparatus 103b from the MTU between apparatuses (1,300 bytes)

Moreover, the network-connected apparatus 102a has already received the optimum MTU (1,250 bytes) between the logical network control apparatuses 103a and 103b from the logical network control apparatus 103a as the MTU notification event. Then, the network-connected apparatus 102a performs the communication based on the received optimum MTU.

Furthermore, the network-connected apparatus 102b also has performed the communication based on the optimum MTU in the communication between the logical network control apparatus 103a and the logical network control apparatus 103b.

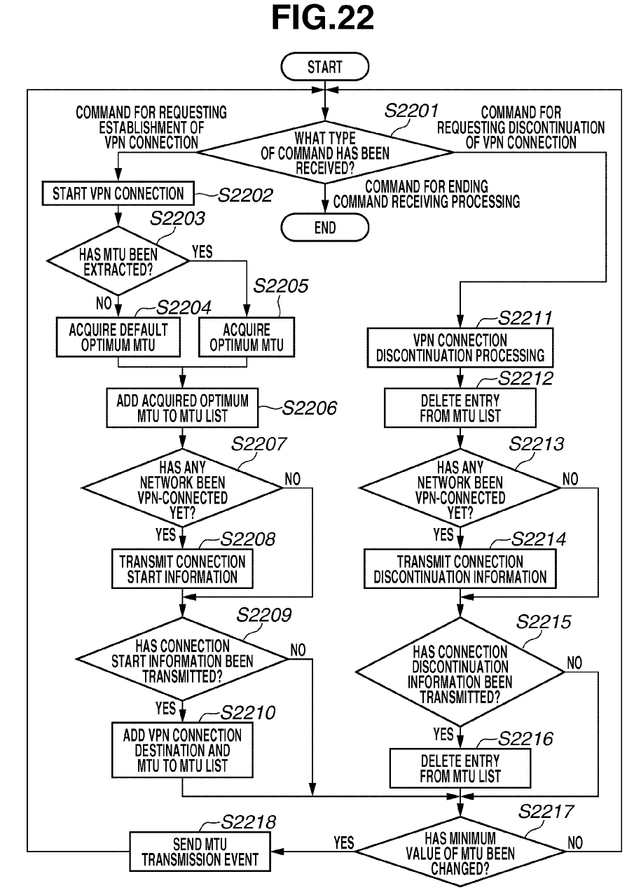

Now, processing performed by the logical network control apparatus 103a after receiving a VPN construction request transmitted by the logical network control apparatus 103c will be described in detail below with reference to FIG. 22. FIG. 22 is a flow chart that illustrates an example of processing performed when the logical network control apparatus 103a receives a VPN construction or discontinuation request from the logical network control apparatus 103 of another network.

Referring to FIG. 22, in step S2201, the logical network control unit 500 of the logical network control apparatus 103a receives a VPN construction request for starting the VPN connection from the logical network control apparatus 103c.

In step S2202, the logical network control unit 500 starts the VPN connection with the logical network control apparatus 103c according to the received VPN construction request.

In step S2203, the MTU measurement unit 502 of the logical network control apparatus 103a detects the MTU between apparatuses in the connection between the logical network control apparatus 103a and the logical network control apparatus 103c and transfers the detected MTU between apparatuses to the logical network control unit 500.

More specifically, the MTU measurement unit 502 detects the data length of a communication packet that can be transmitted via the logical connection (VPN) without being divided.

In step S2205, the logical network control unit 500 subtracts the data length of the information about the VPN from the MTU between apparatuses transmitted in step S2203 to acquire the optimum MTU. In the present exemplary embodiment, the MTU between apparatuses in the communication between the logical network control apparatuses 103a and 103c is 1,200 bytes.

The logical network control apparatus 103a subtracts the data length (50 bytes) of the information about the VPN from the detected MTU between apparatuses (1,200 bytes) to acquire the optimum MTU. As a result of the calculation, the optimum MTU acquired in step S2205 is 1,150 bytes.

In step S2206, the logical network control unit 500 of the logical network control apparatus 103a stores the entry (the VPN connection destination and information about the MTU between apparatuses and the optimum MTU) of the logical network control apparatus 103c in the MTU list. Note that the VPN connection destination included in the entry includes the address that provides an access to the logical network control apparatus 103c.

FIG. 12 illustrates an example of an MTU list stored by the logical network control unit 500 of the logical network control apparatus 103a after the entry of the logical network control apparatus 103c has been added.

Referring to FIG. 12, the IP address “202.100.1.1”, which is described as the VPN connection destination, is the address that provides an access to the logical network control apparatus 103c. In the present exemplary embodiment, the IP address “202.100.1.1” is the address of the router apparatus 104c, and a setting for DMZ and port forwarding is performed with respect to the router apparatus 104c.

The router apparatus 104c can transfer a packet to the logical network control apparatus 103c. Accordingly, the address is used in communicating with the logical network control apparatus 103c via the Internet.

In step S2207, the logical network control unit 500 of the logical network control apparatus 103a determines whether a network that has already been VPN-connected exists. In the example illustrated in FIG. 11, the logical network control apparatus 103a has already started the VPN connection with the logical network control apparatus 103b.

In step S2208, the logical network control unit 500 of the logical network control apparatus 103a refers to the MTU between list and reads the entry of the logical network control apparatus 103b from the MTU list. Then, the logical network control unit 500 of the logical network control apparatus 103a transmits the connection start information including the entry to the logical network control apparatus 103c.

The entry, as described above, includes the VPN connection destination that has been VPN-connected before the logical network control apparatus 103a starts the VPN connection in step S902 and information about the MTU between apparatuses and the optimum MTU in the VPN. Note that the VPN connection destination includes an address that provides an access to the logical network control apparatus 103b.

Furthermore, in step S2208, the logical network control unit 500 of the logical network control apparatus 103a transmits the connection start information including the entry of the logical network control apparatus 103c to the logical network control apparatus 103b, which has already been VPN-connected. After receiving the connection start information from the logical network control apparatus 103a, the logical network control unit 500 of the logical network control apparatus 103c adds the entry of the logical network control apparatus 103b to the MTU list.

Furthermore, after receiving the connection start information from the logical network control apparatus 103a, the logical network control unit 500 of the logical network control apparatus 103b adds the entry of the logical network control apparatus 103c to the MTU list. In step S2209, the logical network control unit 500 of the logical network control apparatus 103a determines whether the connection start information has been transmitted from the logical network control apparatus 103c. If it is determined in step S2209 that the connection start information has been transmitted from the logical network control apparatus 103c (YES in step S2209), then the processing advances to step S2210. On the other hand, if it is determined in step S2209 that the connection start information has not been transmitted from the logical network control apparatus 103c (NO in step S2209), then the processing advances to step S2217.

In step S2210, the logical network control unit 500 adds the entry (the VPN connection destination, the MTU between apparatuses, and the optimum MTU) included in the connection start information to the MTU list.

The entry includes information such as the VPN connection destination that has been VPN-connected before the logical network control apparatus 103c starts the VPN connection with the logical network control apparatus 103a. In addition, the entry includes the MTU between apparatuses and the optimum MTU in the VPN. The logical network control apparatus 103a can utilize the entry in notifying the MTU to the network-connected apparatus 102a.

That is, the optimum MTU included in the entry added in step S2210 can be considered in determining the minimum value of the optimum MTU in step S2217, which will be described in detail later below.

When the processing in step S2210 is completed, the processing advances to step S2217.

As described above, by performing the processing in step S2210, the present exemplary embodiment can perform the communication by using a packet of the size determined according to the changed MTU in the case where one logical network control apparatus performs the VPN connection with a plurality of logical network control apparatuses.

However, in the example illustrated in FIG. 22, the logical network control apparatus 103c has not been VPN-connected with an apparatus other than the logical network control apparatus 103a. Accordingly, the logical network control unit 500 does not perform the processing in step S2210.

In step S2217, the logical network control unit 500 of the logical network control apparatus 103a determines whether the minimum value of the optimum MTU stored in the MTU list has been changed.

In the example illustrated in FIG. 22, the previously acquired optimum MTU in the communication between the logical network control apparatus 103a and the logical network control apparatus 103b is 1,250 bytes. On the other hand, the optimum MTU in the communication between the logical network control apparatus 103a and the logical network control apparatus 103c, which is newly added in step S2206 as described above, is 1,150 bytes. Accordingly, in step S2217, the logical network control unit 500 of the logical network control apparatus 103a determines that the minimum value of the optimum MTU has been changed.

In this regard, in step S2217, the logical network control unit 500 reads the optimum MTU between the logical network control apparatus 103a and the logical network control apparatus 103c, which has newly become the minimum value of the optimum MTU.

More specifically, the logical network control unit 500 acquires information (the optimum MTU) corresponding to the data length detected in step S2203 when the status of the logical connection of another network (the LAN 101c) is changed. In step S2218, the event control unit 501 of the logical network control apparatus 103a transmits an event for notifying the changed minimum value of the optimum MTU (1,150 bytes) to the network-connected apparatus 102a, on which the MTU notification event is registered.

More specifically, the event control unit 501 notifies, to the network-connected apparatus 102a on the LAN 101a, information (the optimum MTU) corresponding to the data length of a communication packet that can be transmitted via the logical connection (VPN) without being divided, which is acquired in step S2217.

Then, the network-connected apparatus 102a receives the notified optimum MTU with the event control unit 401. Furthermore, the network-connected apparatus 102a changes the MTU to be applied with the MTU application unit 403.

As described above, the logical network control apparatus 103a acquires information corresponding to the data length of a communication packet that can be transmitted via the logical connection without being divided when the status of connection of another network to the logical connection (VPN) is changed. In the example illustrated in FIG. 22, when the LAN 101c is connected to the VPN, then in step S2217, the logical network control apparatus 103a acquires information (the optimum MTU) corresponding to the data length (the MTU between apparatuses) of a communication packet that can be transmitted via the logical connection without being divided.

In step S2218, the event control unit 501 notifies the acquired information (the optimum MTU) to the network-connected apparatus 102a (the communication apparatus) on the LAN 101a (the first network), on which the MTU notification event is registered.

With the above-described configuration, the present exemplary embodiment can perform the communication by using a packet of the size determined according to the changed data length when the data length of the communication packet is changed.

Note that in the present exemplary embodiment, as described above, the MTU notification event is transmitted If it is determined that the optimum MTU acquired when the VPN-connected connection destination participates the network is smaller than the minimum value of the optimum MTU stored in the MTU list. With the above-described configuration, the present exemplary embodiment can effectively perform processing for notifying and receiving the MTU notification event.

However, the present exemplary embodiment is not limited to this. That is, it is also useful if the optimum MTU is notified every time a VPN connection with another network newly starts and the network-connected apparatus 102a determines the MTU to be applied.

Furthermore, in the determination processing in step S2217, the comparison with respect to the optimum MTU is performed. However, the present exemplary embodiment is not limited to this. That is, it is also useful if the comparison is performed by using the MTU between apparatuses.

Furthermore, in the present exemplary embodiment, the optimum MTU is notified in step S2218. However, the present exemplary embodiment is not limited to this. That is, it is also useful if the MTU between apparatuses and the data length of information added with respect to the VPN communication, for example, can be notified.

Note that, in the above-described example, the VPN connection is constructed according to the VPN construction request from the logical network control apparatus 103c. However, the present exemplary embodiment is not limited to this. That is, it is also useful if the VPN connection is constructed according to a VPN construction request from the logical network control apparatus 103a.

Now, processing performed by the logical network control apparatus 103a in the case where a VPN connection request is transmitted from the logical network control apparatus 103a to the logical network control apparatus 103c will be described in detail below with reference to FIG. 9.

Referring to FIG. 9, in step S901, the logical network control unit 500 of the logical network control apparatus 103a receives the VPN connection request for starting the VPN connection with the logical network control apparatus 103c from the network-connected apparatus 102a. Then, the processing advances to step S902.

In step S902, the logical network control unit 500 starts the VPN connection with the logical network control apparatus 103c according to the address information included in the VPN connection request. Then, the processing advances to step S903.

In step S903, the MTU measurement unit 502 of the logical network control apparatus 103a detects the MTU between apparatuses in the connection between the logical network control apparatus 103a and the logical network control apparatus 103c.

More specifically, the MTU measurement unit 502 detects the data length of a communication packet that can be transmitted via the logical connection (VPN) without being divided. After detecting the data length of a communication packet that can be transmitted via the logical connection (VPN) without being divided, the MTU measurement unit 502 transmits the detected MTU between apparatuses to the logical network control unit 500. Then, the processing advances to step S905. In the example illustrated in FIG. 9, the MTU between apparatuses (1,200 bytes) in the connection between the logical network control apparatuses 103a and 103c is detected.

In step S905, the logical network control unit 500 performs the following calculation to acquire the optimum MTU. That is, the logical network control unit 500 subtracts the data length (50 bytes) of the information added with respect to the VPN communication from the MTU between apparatuses transmitted in step S903 to acquire the optimum MTU. Then, the processing advances to step S906.

In step S906, the logical network control unit 500 adds the entry (the address information, the MTU between apparatuses, and the optimum MTU) of the logical network control apparatus 103c to the MTU list. Then, the processing advances to step S907.

The entry added here includes an address (address information) that provides an access to the logical network control apparatus 103c and the MTU between apparatuses and the optimum MTU in the VPN between the logical network control apparatuses 103a and 103c.

In step S907, the logical network control unit 500 determines whether another logical network control apparatus that has already been VPN-connected with the logical network control apparatus 103a exists other than the logical network control apparatus 103b. In the present exemplary embodiment, the logical network control unit 500 determines that the VPN connection with the logical network control apparatus 103b has already been constructed. Then, the processing advances to step S908.

In step S908, the logical network control unit 500 of the logical network control apparatus 103a transmits the connection start information including the entry of the logical network control apparatus 103b to the logical network control apparatus 103c.

The entry includes information such as an address that provides an access to the logical network control apparatus 103b. In addition, the entry includes the MTU between apparatuses and the optimum MTU in the VPN between the logical network control apparatuses 103a and 103b.

In step S908, the logical network control unit 500 transmits the connection start information including the entry of the logical network control apparatus 103c to the logical network control apparatus 103b. Then, the processing advances to step S909.

Here, the connection start information includes the address that provides an access to the logical network control apparatus 103c and information about the MTU between apparatuses and the optimum MTU in the VPN between the logical network control apparatus 103a and the logical network control apparatus 103c.

In step S909, the logical network control unit 500 of the logical network control apparatus 103a determines whether the connection start information has been transmitted from the logical network control apparatus 103c. In the present exemplary embodiment, the logical network control apparatus 103c has not been VPN-connected with an apparatus other than the logical network control apparatus 103a. Accordingly, the processing advances to step S917.

In step S917 (acquisition processing), the logical network control unit 500 determines whether the minimum value of the optimum MTU stored in the MTU list has been changed. In the present exemplary embodiment, the logical network control unit 500 determines that the minimum value of the optimum MTU has been changed to the optimum MTU (1,150 bytes) for the communication with the logical network control apparatus 103c.

In this regard, the logical network control unit 500 of the logical network control apparatus 103a reads the changed optimum MTU in the communication with the logical network control apparatus 103c. Then, the processing advances to step S918.

More specifically, the logical network control unit 500 acquires information corresponding to the data length of a communication packet that can be transmitted via the logical connection without being divided when the status of the logical connection of another network (the LAN 101c) is changed.

In step S918 (the notification processing), the event control unit 501 transmits the optimum MTU read in step S917 as the MTU notification event to the network-connected apparatus 102a (the communication apparatus), on which the MTU notification event is registered.

More specifically, the event control unit 501 notifies, to the communication apparatus (the network-connected apparatus 102a) on the LAN 101a (the first network), information (the optimum MTU) corresponding to the data length of a communication packet that can be transmitted via the logical connection (VPN) without being divided acquired in step S917. Then, the network-connected apparatus 102a receives the notified optimum MTU with the event control unit 401. Furthermore, the network-connected apparatus 102a changes the MTU to be applied by using the MTU application unit

On the other hand, the logical network control apparatus 103b acquires the entry (the VPN connection destination, the MTU between apparatuses (1,200 bytes), and the optimum MTU (1,150 bytes) included in the connection start information transmitted in step S908 from the logical network control apparatus 103a. Note that in this case, the VPN connection destination includes the address that provides an access to the logical network control apparatus 103c.

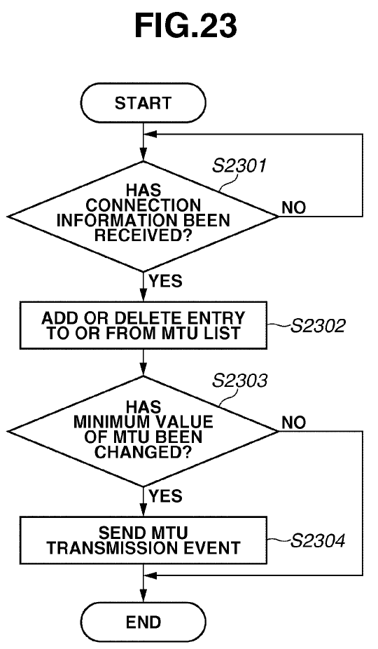

Now, processing performed by the logical network control apparatus 103b after receiving the connection information (the connection start information or the connection discontinuation information) transmitted from the logical network control apparatus 103a will be described in detail below with reference to FIG. 23.

Referring to FIG. 23, in step S2301, the logical network control unit 500 of the logical network control apparatus 103b receives connection information transmitted from the logical network control apparatus 103a and determines the type of the received connection information. When the logical network control unit 500 receives the connection information (YES in step S2301), the process proceeds to step S2302. In step S2302, if the received connection information in step S2301 is the connection start information, the logical network control unit 500 of the logical network control apparatus 103b adds the entry included in the received connection information to the MTU list.

On the other hand, if the received connection information in step S2301 is the connection discontinuation information, then in step S2302, the logical network control unit 500 of the logical network control apparatus 103b deletes the entry from an MTU size list according to the address of the connection destination address included in the received connection discontinuation information. In step S2303, the logical network control unit 500 of the logical network control apparatus 103b determines whether the minimum value of the optimum MTU stored in the MTU list has been changed.

In the present exemplary embodiment, the optimum MTU in the communication with the logical network control apparatus 103a, which has been previously acquired and stored in the MTU list, is 1,250 bytes, while the optimum MTU in the communication with the logical network control apparatus 103c, which is newly added in step S2302, is 1,150 bytes. Accordingly, in step S2303, the logical network control unit 500 of the logical network control apparatus 103b determines that the minimum value of the optimum MTU has been changed. If the minimum value of MTU has been changed (YES in step S2303), the process proceeds to step S2304.

In step S2304, the event control unit 501 notifies the changed minimum value of the optimum MTU to the network-connected apparatus 102b, on which the MTU notification is registered.

As described above, the logical network control apparatus 103a acquires information corresponding to the data length of a communication packet that can be transmitted via the logical connection without being divided when the status of connection of another network to the logical network (VPN) is changed. In the present exemplary embodiment, in step S917, when the LAN 101c participates in the VPN, the logical network control apparatus 103a and acquires information (the optimum MTU) corresponding to the data length (the MTU between apparatuses) of a communication packet that can be transmitted via the logical connection without being divided.

In step S918, the event control unit 501 notifies the acquired information (the optimum MTU) to the network-connected apparatus 102a (the communication apparatus) on the LAN 101a (the first network), on which the MTU notification event is registered of.

With the above-described configuration, the present exemplary embodiment can perform the communication by using a packet of the size determined according to the changed data length when the data length of the communication packet is changed.

Now, processing performed when the logical network control apparatus 103a on the LAN 101a, which is VPN-connected with each of the logical network control apparatuses 103b and 103c, receives a VPN discontinuation request from the logical network control apparatus 103c will be described in detail below with reference to FIG. 22.

Note that the logical network control apparatus 103a is a relay apparatus that is connected to the LAN 101a (the first network) and logically connects the LAN 101a and another network so that a communication packet can be transmitted between the LAN 101a and another network. The logical network control apparatus 103a relays the communication data received from the network-connected apparatus 102a (the communication apparatus) to the communication apparatus on another network via the logical connection (VPN) (the relay processing).

Furthermore, each of the logical network control apparatuses 103b and 103c is the relay apparatus that connects the logical network (VPN) to the corresponding LAN 101b (another network) or LAN 101c (another network).

Furthermore, each of the logical network control apparatuses 103a, 103b, and 103c stores the entry of the corresponding logical network control apparatus 103a, 103b, or 103c in the MTU list. Accordingly, the MTU list stored in the logical network control apparatus 103a is as illustrated in FIG. 12, for example.

In step S2201, the logical network control unit 500 of the logical network control apparatus 103a receives a request for discontinuing the VPN connection from the logical network control apparatus 103c. Then, the processing advances to step S2211.

In step S2211, the logical network control unit 500 of the logical network control apparatus 103a performs the processing for discontinuing the VPN connection with the logical network control apparatus 103c. Then, the processing advances to S2212.

In step S2212, the logical network control unit 500 of the logical network control apparatus 103a deletes the entry of the logical network control apparatus 103c from the MTU list stored therein. Then, the processing advances to step S2213. Here, the size of the MTU after deleting the entry of the logical network control apparatus 103c as described above is as illustrated in FIG. 13.

Returning to FIG. 22, in step S2213, the logical network control unit 500 of the logical network control apparatus 103a determines whether any other VPN-connected network exists.

In the example illustrated in FIG. 22, the logical network control apparatus 103a has constructed the VPN connection with the logical network control apparatus 103b. Accordingly, the logical network control unit 500 of the logical network control apparatus 103a determines that another network that has already been VPN-connected exists. Then, the processing advances to step S2214.

In step S2214, the logical network control unit 500 notifies, to the logical network control apparatus 103b, connection discontinuation information indicating that the VPN connection with the logical network control apparatus 103c has been discontinued. After receiving the notification in step S2214, the logical network control apparatus 103b performs processing for receiving the connection discontinuation information according to the processing described above with reference to FIG. 23.

More specifically, the logical network control apparatus 103b searches for the entry stored in the MTU list based on the information about the VPN connection destination included in the connection discontinuation information and deletes the entry extracted as a result of the search.

The result of the search can be utilized in notifying the MTU to the network-connected apparatus 102b. That is, it can be considered that the entry has been deleted in determining whether the minimum value of the optimum MTU has been changed.

Furthermore, in step S2214, the logical network control unit 500 transmits, to the logical network control apparatus 103c, the connection discontinuation information indicating that the VPN connection with the logical network control apparatus 103b is discontinued. Then, the processing advances to step S2215.

After receiving the connection discontinuation information, as the logical network control apparatus 103b does, the logical network control apparatus 103c searches for the entry stored in the MTU list based on the information about the VPN connection destination included in the connection discontinuation information and deletes the entry extracted as a result of the search.

The result of the search can be utilized in notifying the MTU to the network-connected apparatus 102c. That is, it can be considered that the entry has been deleted in determining whether the minimum value of the optimum MTU has been changed.

As described above, by performing the processing in step S2214, the present exemplary embodiment can perform the communication by using a packet of the size determined according to the changed MTU when the logical network control apparatuses 103b and 103c have currently been VPN-connected with another logical network control apparatus.

However, in the example illustrated in FIG. 22, the logical network control apparatus 103c has not been VPN-connected with any other logical network control apparatus. Accordingly, the processing in step S2214 can be omitted in this case.

In step S2215, the logical network control unit 500 of the logical network control apparatus 103a determines whether the logical network control apparatus 103c, whose VPN connection has been discontinued, has transmitted connection discontinuation information. Here, similar to the above-described configuration, the connection discontinuation information includes information about the destination of the VPN connection with the logical network control apparatus 103c to be discontinued (the address that provides an access to the logical network control apparatus).

After receiving the connection discontinuation information in step S2215, the processing advances to step S2216. In step S2216, the logical network control apparatus 103a searches for the entry stored in the MTU list based on the VPN connection destination included in the connection discontinuation information and deletes the entry extracted as a result of the search. The result of the search can be utilized in notifying the MTU to the network-connected apparatus 102a.

That is, it can be considered that the entry has been deleted in step S2216 in determining the minimum value of the optimum MTU in step S2217.

With the above-described configuration, the present exemplary embodiment can perform the communication by using a packet of the size determined according to the changed MTU when one logical network control apparatus performs the VPN connection with a plurality of logical network control apparatuses.

In this regard, in the present exemplary embodiment, the logical network control apparatus 103c has not performed the VPN connection with the logical network control apparatus 103 other than the logical network control apparatus 103a. Accordingly, the logical network control unit 500 determines here that the logical network control apparatus 103c has not transmitted the connection discontinuation information in step S2215. Then, the processing advances to step S2217.

In step S2217 (acquisition processing), the logical network control unit 500 determines whether the minimum value of the optimum MTU stored in the MTU list has been changed. In the present exemplary embodiment, the optimum MTU (1,150 bytes) in the communication with the logical network control apparatus 103c, which was the minimum value of the optimum MTU so far, has been deleted. Accordingly, the logical network control unit 500 determines that the minimum value of the optimum MTU has been changed.

Furthermore, in step S2217, the logical network control unit 500 acquires the optimum MTU that has been newly set as the minimum value from the MTU list. In the present exemplary embodiment, the logical network control unit 500 acquires the optimum MTU in the communication with the logical network control apparatus 103b.

More specifically, the logical network control unit 500 acquires information corresponding to the data length of a communication packet that can be transmitted via the logical connection without being divided when the status of the logical connection of another network is changed.

In the present exemplary embodiment, when the VPN connection to the LAN 101c is discontinued as described above, the logical network control unit 500 acquires the information (the optimum MTU) corresponding to the data length (the MTU between apparatuses) of a communication packet that can be transmitted to the LAN 101b without being divided, which has been newly set as the minimum value of the optimum MTU.

After acquiring the minimum value of the optimum MTU in step S2217, the processing advances to step S2218.

In step S2218 (notification processing), the event control unit 501 of the logical network control apparatus 103a transmits the changed optimum MTU to the network-connected apparatus 102a on the LAN 101a, on which the MTU notification event is registered.

More specifically, the event control unit 501 notifies the information (the optimum MTU) acquired in step S2217 to the network-connected apparatus 102a (the communication apparatus) on the LAN 101a (the first network) More specifically, the event control unit 501 notifies the optimum MTU to the communication apparatus on the first network.

As described above, in the present exemplary embodiment, the optimum MTU is notified in step S2218. However, the present exemplary embodiment is not limited to this. That is, any information with which the optimum MTU can be calculated by the network-connected apparatus 102a based thereon can be used as the information to be notified. For example, it is also useful to notify the MTU between apparatuses and the data length added to the relay apparatus with respect to the VPN communication.

After receiving the event from the logical network control apparatus 103a transmitted in step S2218 with the event control unit 401, the network-connected apparatus 102a uses the MTU application unit 403 to change the MTU to be applied.

The logical network control apparatus 103a performs the following processing when the status of connection of another network (the LAN 101c) to the logical network (the VPN) is changed.

That is, at first, the logical network control apparatus 103a acquires information corresponding to the data length of a communication packet that can be transmitted via the logical connection (VPN) without being divided. In the present exemplary embodiment, the logical network control apparatus 103a acquires the information corresponding to the data length of a communication packet that can be transmitted to another network (the LAN 101b) without being divided.

Then, the logical network control apparatus 103a notifies the acquired information (the optimum MTU) to the network-connected apparatus 102a (the communication apparatus) on the LAN 101a (the first network).

With the above-described configuration, the present exemplary embodiment can perform the communication by using a packet of the size determined according to the changed data length when the data length of the communication packet is changed.

In the present exemplary embodiment, the logical network control apparatus 103c transmits a request for discontinuing the VPN connection. However, the present exemplary embodiment is not limited to this. That is, it is also useful if the logical network control apparatus 103a transmits a VPN discontinuation request to the logical network control apparatus 103c. In this case, the logical network control apparatus 103a performs the VPN connection discontinuation processing according to the processing illustrated in FIG. 9.

That is, in this case, in step S901, when the logical network control apparatus 103c receives a VPN discontinuation request from the network-connected apparatus 102a, the logical network control unit 500 of the logical network control apparatus 103a advances to step S911.

In step S911, the logical network control unit 500 performs the processing for discontinuing the VPN connection with the logical network control apparatus 103c. Then, the processing advances to S912.

In step S912, the logical network control unit 500 deletes the entry of the logical network control apparatus 103c from the MTU list. Then, the processing advances to step S913.

In step S913, the logical network control unit 500 determines whether another VPN-connected logical network control apparatus exists. In the present exemplary embodiment, the VPN connection with the logical network control apparatus 103b has been performed.

Accordingly, in this case, the logical network control unit 500 determines that another VPN-connected logical network control apparatus exists. Then, the processing advances to step S914.

In step S914, the logical network control unit 500 transmits, to the logical network control apparatus 103b that has already been VPN-connected, the connection discontinuation information indicating that the VPN connection with the logical network control apparatus 103c has been discontinued.

Furthermore, in step S914, the logical network control unit 500 of the logical network control apparatus 103a transmits, to the logical network control apparatus 103c, the connection discontinuation information indicating that the VPN connection with the logical network control apparatus 103b has been discontinued. Then, the processing advances to step S915.

By performing the processing in step S914, the present exemplary embodiment can perform the communication by using a packet of the size determined according to the changed MTU when the logical network control apparatus 103c is currently VPN-connected.

In the present exemplary embodiment, the logical network control apparatus 103c has not been VPN-connected with any other logical network control apparatus. Accordingly, the processing in step S914 can be omitted.

In step S915, the logical network control unit 500 determines whether the connection discontinuation information has been transmitted from the logical network control apparatus 103c whose VPN connection has been discontinued in step S911.

In the present exemplary embodiment, the logical network control apparatus 103c has not been VPN-connected with any other logical network control apparatus. Accordingly, the logical network control unit 500 determines that the logical network control apparatus 103c has not transmitted the connection discontinuation information. Then, the processing advances to step S917.

In step S917 (acquisition processing), the logical network control unit 500 determines whether the minimum value of the optimum MTU of the MTU list has been changed. In the present exemplary embodiment, the optimum MTU (1,150 bytes) of the logical network control apparatus 103c, which has been the minimum value of the optimum MTU so far, is deleted. Accordingly, the logical network control unit 500 determines that the minimum value of the optimum MTU has been changed.

In step S917, the logical network control unit 500 acquires the optimum MTU (1,250 bytes) that has been newly set as the minimum value of the optimum MTU.

More specifically, the logical network control unit 500 acquires information corresponding to the data length of a communication packet that can be transmitted via the logical connection without being divided when the status of the logical connection of another network is changed. In the present exemplary embodiment, when the VPN connection of the LAN 101c is discontinued, the logical network control unit 500 acquires the information (the optimum MTU) corresponding to the data length (the MTU between apparatuses) of a communication packet that can be transmitted to the LAN 101b without being divided, which is newly set as the new minimum value of the optimum MTU.

After the logical network control unit 500 acquires the new minimum value of the optimum MTU in step S917, then the processing advances to step S918.

In step S918 (notification processing), the event control unit 501 transmits an event for notifying the optimum MTU (1,250 bytes) in the communication with the logical network control apparatus 103b, which has been newly set as the minimum value of the optimum MTU between, to the network-connected apparatus 102a.

More specifically, the event control unit 501 notifies the information (the optimum MTU) acquired in step S917 to the network-connected apparatus 102a (the communication apparatus) on the LAN 101a (the first network).

In the present exemplary embodiment, in step S918, the event control unit 501 notifies the optimum MTU. However, the present exemplary embodiment is not limited to this. That is, the network-connected apparatus 102a can notify any type of information that the optimum MTU can be acquired based thereon.

In this regard, it is also useful if the MTU between apparatuses and the data length of the information added to the relay apparatus with respect to the VPN communication are notified.

As described above, the logical network control apparatus 103a transmits the MTU notification event when the minimum value of the optimum MTU is changed as the VPN connection is discontinued. With the above-described configuration, the present exemplary embodiment can effectively perform the processing for notifying and receiving the MTU notification event.

However, the present exemplary embodiment is not limited to this. That is, it is also useful if the optimum MTU related to the destination of the discontinued connection every time a VPN connection is discontinued and if the logical network control unit 500 of the network-connected apparatus 102a determines the MTU to be applied and utilized. When the status of connection of another network (the LAN 101c) to the logical network (VPN) is changed as described above, the logical network control apparatus 103a performs the following processing.

That is, in this regard, at first, the logical network control apparatus 103a acquires information corresponding to the data length of a communication packet that can be transmitted via the logical connection without being divided. In the present exemplary embodiment, the logical network control unit 500 of the logical network control apparatus 103a acquires information corresponding to the data length of a communication packet that can be transmitted to another network (the LAN 101b) without being divided.

In addition, the logical network control unit 500 notifies the information (the optimum MTU) corresponding to the acquired data length to the network-connected apparatus 102a (the communication apparatus) on the LAN 101a (the first network). With the above-described configuration, the present exemplary embodiment can perform the communication by using a packet of the size determined according to the changed data length.

Now, processing for VPN-connecting the logical network control apparatus 103b, which has already been VPN-connected with the logical network control apparatus 103a, to the logical network control apparatus 103c at the same time will be described in detail below. In the present exemplary embodiment, the logical network control apparatus 103a is a relay apparatus that is connected to the LAN 101a (the first network) and logically connects the LAN 101a and another network so that a communication packet can be transmitted between the LAN 101a and another network.

Furthermore, in the present exemplary embodiment, the logical network control apparatus 103b is a second relay apparatus that is connected to the LAN 101b (a second network) and connects the LAN 101b to the logical network (VPN). In addition, the logical network control apparatus 103a receives communication data from the network-connected apparatus 102a (the communication apparatus) on the LAN 101a.

Furthermore, the logical network control apparatus 103a relays the received communication data to the communication apparatus (the network-connected apparatus 102b) on the LAN 101b via the logical network control apparatus 103b (the second relay apparatus) (relay processing).

Furthermore, the logical network control apparatus 103c is a relay apparatus that connects the LAN 101c (another network) to the logical network (VPN).

Note that it is supposed here that the network-connected apparatus 102a has completed the processing for registering the event related to notifying the MTU in the communication with the logical network control apparatus 103a, which is described above with reference to FIGS. 6, 7, and 8.

It is also supposed here that in the same way, each of the network-connected apparatuses 102b and 102c has completed the processing for registering the event related to notifying the MTU in the communication with the corresponding logical network control apparatus 103b or 103c, which is described above with reference to FIGS. 6, 7, and 8.

Furthermore, it is also supposed here that the logical network control apparatus 103a has already started a VPN connection with the logical network control apparatus 103b. FIG. 11 illustrates an example of the MTU list stored by the logical network control unit 500 of the logical network control apparatus 103a.

Furthermore, here, after receiving the MTU notification event from the logical network control apparatus 103a, the network-connected apparatus 102a has constructed a communication based on the optimum MTU (1,250 bytes) in the communication with each of the logical network control apparatuses 103a and 103b. In the present exemplary embodiment, processing performed when the logical network control apparatus 103c issues a VPN connection request to the logical network control apparatus 103b will be described. That is, in the following description, the operation of the logical network control apparatus 103b performed in this case will be described with reference to FIG. 22, while the operation of the logical network control apparatus 103a performed in this case will be described with reference to FIG. 23.

When the network-connected apparatus 102c issues, to the logical network control apparatus 103c, a request for constructing a VPN connection with the logical network control apparatus 103b, the logical network control apparatus 103c transmits a VPN construction request to the logical network control apparatus 103b.

Referring to FIG. 22, in step S2201, the logical network control unit 500 of the logical network control apparatus 103b receives the VPN construction request. Then, the processing advances to step S2202.

In step S2202, the logical network control unit 500 of the logical network control apparatus 103b starts the VPN connection with the logical network control apparatus 103c according to the address information included in the received VPN construction request. Then, the processing advances to step S2203.

In step S2203, the MTU measurement unit 502 of the logical network control apparatus 103b detects the MTU between apparatuses in the connection between the logical network control apparatus 103c and the logical network control apparatus 103b. In the present exemplary embodiment, the logical network control unit 500 of the logical network control apparatus 103b detects the MTU between apparatuses (1,200 bytes) between the logical network control apparatuses 103b and 103c. Then, the processing advances to step S2205.

In step S2205, the logical network control unit 500 acquires the optimum MTU (1,150 bytes) calculated by subtracting the data length (50 bytes) of the information about the VPN based on the detected MTU between apparatuses (1,200 bytes). Then, the processing advances to step S2206.

In step S2206, the logical network control unit 500 of the logical network control apparatus 103b stores the entry (the connection destination address, the MTU between apparatuses, and the optimum MTU) of the logical network control apparatus 103c in the MTU list. Then, the processing advances to step S2207.

In step S2207, the logical network control unit 500 of the logical network control apparatus 103b determines whether a network that has already been VPN-connected exists other than the logical network control apparatus 103c. In the present exemplary embodiment, the logical network control apparatus 103b has already been VPN-connected with the logical network control apparatus 103a.

In step S2208, the logical network control unit 500 of the logical network control apparatus 103b reads the entry of the logical network control apparatus 103a from the MTU list. Then the logical network control unit 500 of the logical network control apparatus 103b transmits the connection start information including the read entry to the logical network control apparatus 103c.

The entry includes information such as the address of the logical network control apparatus 103a. In addition, the entry includes the MTU between apparatuses and the optimum MTU in the VPN with the logical network control apparatus 103a.

Furthermore, in step S2208, the logical network control unit 500 transmits the connection start information including the entry of the logical network control apparatus 103c to the logical network control apparatus 103a, which has already been VPN-connected. Then, the processing advances to step S2209.

The entry includes information such as the address of the logical network control apparatus 103c. In addition, the entry includes the MTU between apparatuses and the optimum MTU in the VPN with the logical network control apparatus 103c.

Now, processing performed by the logical network control apparatus 103a after receiving the connection start information transmitted in step S2208 will be described in detail below with reference to FIG. 23.

Referring to FIG. 23, in step S2301, the logical network control unit 500 receives the connection start information from the logical network control apparatus 103b. Then, the processing advances to step S2302.

In step S2302, the logical network control unit 500 adds the entry of the logical network control apparatus 103c included in the received connection start information in step S2301 to the MTU list. Then, the processing advances to step S2303.

In step S2303 (the acquisition processing), the logical network control unit 500 determines whether the minimum value of the optimum MTU stored in the MTU list has been changed. If it is determined in step S2303 that the minimum value of the optimum MTU has been changed (YES in step S2303), then the logical network control unit 500 acquires the new minimum value of the optimum MTU from the MTU list. Then, the processing advances to step S2304.

On the other hand, if it is determined in step S2303 that the minimum value of the optimum MTU has not been changed (NO in step S2303), then the entry receiving processing ends.

More specifically, the logical network control unit 500 receives the notification of the connection information (the connection start information) from the logical network control apparatus 103b when the status of the logical connection between the logical network control apparatus 103b (the second relay apparatus) and each of the LAN 101b (the second network) and another network is changed.

In addition, the logical network control apparatus 500 acquires information corresponding to the data length of a communication packet that can be transmitted via the logical connection without being divided based on the received connection information.

In the present exemplary embodiment, the logical network control unit 500 acquires information (the optimum MTU) corresponding to the data length of a communication packet that can be transmitted to the LAN 101c without being divided when the LAN 101c (another network) is newly connected to (participates in) the VPN.

In step S2304 (notification processing), the event control unit 501 notifies the optimum MTU (1,150 bytes) in the communication with the logical network control apparatus 103c as the MTU notification event to the network-connected apparatus 102a on the LAN 101a, on which the MTU notification event is registered.

More specifically, the event control unit 501 notifies the information acquired in step S2303 to the communication apparatus (the network-connected apparatus 102a) on the LAN 101a (the first network). That is, the event control unit 501 notifies the information acquired in step S2303 to the communication apparatus on the first network.

After receiving the event transmitted in step S2304, the network-connected apparatus 102a changes the MTU to be applied using the MTU application unit 403.

With the above-described configuration, the present exemplary embodiment can perform the communication by using a packet of the size determined according to the changed MTU in the case where one logical network control apparatus performs the VPN connection with a plurality of logical network control apparatuses.

In step S2209, the logical network control unit 500 of the logical network control apparatus 103b determines whether the connection start information has been transmitted from the logical network control apparatus 103c. If it is determined in step S2209 that the connection start information has been transmitted from the logical network control apparatus 103c (YES in step S2209), then the processing advances to step S2210. On the other hand, if it is determined in step S2209 that the connection start information has not been transmitted from the logical network control apparatus 103c (NO in step S2209), then the processing advances to step S2217.

In the present exemplary embodiment, the logical network control apparatus 103c has not been VPN-connected with any other the logical network control apparatus. Accordingly, the processing advances to step S2217.

In step S2217, the logical network control unit 500 of the logical network control apparatus 103b determines whether the minimum value of the optimum MTU of the MTU list has been changed. In the present exemplary embodiment, the optimum MTU in the communication with the logical network control apparatus 103a that has been previously acquired and stored in the MTU list is 1,250 bytes, while the optimum MTU between in the communication with the logical network control apparatus 103c that is newly acquired is 1,150 bytes.

Accordingly, in step S2217, the logical network control unit 500 of the logical network control apparatus 103b acquires the optimum MTU (1,150 bytes) in the communication with the logical network control apparatus 103c from the MTU list. In step S2218, the event control unit 501 of the logical network control apparatus 103b issues an MTU notification event to the network-connected apparatus 102b on the LAN 101b (the second network). Then, the VPN connection processing ends.

As described above, the logical network control unit 500 of the logical network control apparatus 103a receives the notification of the connection information (the connection start information) from the logical network control apparatus 103b in step S2301 when the status of the logical connection between the logical network control apparatus 103b (the second relay apparatus) and each of the LAN 101b (the second network) and another network is changed.

In step S2303, the logical network control unit 500 acquires information (the optimum MTU) corresponding to the data length of a communication packet that can be transmitted via the LAN 101c (another network) without being divided according to the entry included in the received connection start information. Furthermore, the event control unit 401 notifies the information (the optimum MTU) corresponding to the data length acquired in step S2304 to the network-connected apparatus 102a (the communication apparatus) on the LAN 101a (the first network).

With the above-described configuration, the present exemplary embodiment can perform the communication by using a packet of the size determined according to the changed data length when the data length of the communication packet is changed.

Now, processing for discontinuing the VPN connection with the logical network control apparatus 103c performed by the logical network control apparatus 103b VPN-connected with each of the logical network control apparatus 103a and the logical network control apparatus 103c will be described in detail below with reference to FIGS. 22 and 23. Note that it is supposed here that the network-connected apparatuses 102a, 102b, and 102c has already completed the processing for registering the event related to notifying the MTU performed in the communication with the corresponding logical network control apparatus 103a, 103b, or 103c, which is described above with reference to FIGS. 6, 7, and 8.

Furthermore, it is also supposed here that the logical network control apparatus 103a has already started a VPN connection with the logical network control apparatus 103b. In addition, it is supposed here that the logical network control apparatus 103b has already started a VPN connection with the logical network control apparatus 103c.

The logical network control apparatus 103a relays the communication data received from the network-connected apparatus 102a (the communication apparatus) to the communication apparatus on another network via the logical connection (VPN) (relay processing).

FIG. 12 illustrates an example of the MTU list stored by the logical network control unit 500 of the logical network control apparatus 103a. Here, the network-connected apparatus 102a has performed the communication by using the optimum MTU bytes) in the communication between the logical network control apparatuses 103b and 103c, which has been received from the logical network control apparatus 103a as the MTU notification event.

Referring to FIG. 22, the logical network control unit 500 of the logical network control apparatus 103b determines the type of the request received from the logical network control apparatus 103c. If a request for discontinuing the VPN is received from the logical network control apparatus 103c in step S2201, then the processing advances to step S2211.

In step S2211, the logical network control unit 500 of the logical network control apparatus 103b performs processing for discontinuing the VPN connection with the logical network control apparatus 103c. Then, the processing advances to S2212.

In step S2212, the logical network control unit 500 of the logical network control apparatus 103b deletes the entry of the logical network control apparatus 103c from the MTU list stored therein. Then, the processing advances to step S2213.

In step S2213, the logical network control unit 500 of the logical network control apparatus 103b determines whether any VPN-connected network exists other than the logical network control apparatus 103c whose VPN connection has been discontinued in step S2211.

In the present exemplary embodiment, the logical network control apparatus 103b has constructed the VPN connection with the logical network control apparatus 103a. Accordingly, the logical network control unit 500 determines that a VPN-connected network exists other than the logical network control apparatus 103c whose VPN connection has been discontinued in step S2211. Then, the processing advances to step S2214.

In step S2214, the logical network control unit 500 notifies the connection discontinuation information indicating that the VPN connection with the logical network control apparatus 103c has been discontinued to the logical network control apparatus 103a. Then, the processing advances to step S2215.

Now, processing performed by the logical network control apparatus 103a after receiving the connection discontinuation information (the connection information) transmitted in step S2214 will be described in detail below with reference to FIG. 23.

In step S2301, the logical network control unit 500 of the logical network control apparatus 103a receives the connection discontinuation information from the logical network control apparatus 103b. Then, the processing advances to step S2302.

In step S2302, the logical network control unit 500 deletes, from the MTU list, the entry corresponding to the address that provides an access to the logical network control apparatus 103c included in the connection discontinuation information that has been received step S2301. Then, the processing advances to step S2303.

In step S2303 (acquisition processing), the logical network control unit 500 determines whether the minimum value of the optimum MTU stored in the MTU list has been changed. If it is determined in step S2303 that the minimum value of the optimum MTU has been changed (YES in step S2303), then the logical network control unit 500 acquires the new minimum value of the optimum MTU. Then, the processing advances to step S2304. On the other hand, if it is determined in step S2303 that the minimum value of the optimum MTU has not been changed (NO in step S2303), then the processing for receiving the connection information ends.

In the present exemplary embodiment, the logical network control apparatus 103a applies the optimum MTU (1,150 bytes) in the communication with the logical network control apparatus 103c which has been the minimum value of the optimum MTU so far. Furthermore, in step S2303, the entry of the logical network control apparatus 103c is deleted. Accordingly, in this case, the logical network control unit 500 determines that the minimum value of the optimum MTU has been changed.

Note that the minimum value of the optimum MTU to be acquired here is the optimum MTU (1,250 bytes) in the communication with the logical network control apparatus 103b.

More specifically, the logical network control unit 500 of the logical network control apparatus 103a performs the following processing when the status of the logical connection between the logical network control apparatus 103b (the second relay apparatus) and each of the LAN 101b (the second network) and another network is changed.

That is, the logical network control unit 500 receives the notification of connection information (the connection discontinuation information) from the logical network control apparatus 103b. Then, the logical network control apparatus 500 acquires information corresponding to the data length of a communication packet that can be transmitted via the logical connection without being divided according to the received connection information.

In the present exemplary embodiment, the logical network control unit 500 acquires the optimum MTU in the communication with the logical network control apparatus 103b when the VPN connection between the logical network control apparatus 103b and each of the LAN 101b (the second network) and the LAN 101c (another network) is discontinued.

In step S2304 (notification processing), the event control unit 501 notifies the optimum MTU (1,250 bytes) in the communication by the logical network control apparatus 103b to the network-connected apparatus 102a on the LAN 101a, on which the MTU notification event is registered.

More specifically, the event control unit 501 notifies the information acquired in step S2303 to the network-connected apparatus 102a (the communication apparatus) on the LAN 101a (the first network). After receiving the event in step S2304, the network-connected apparatus 102a changes the MTU to be applied by using the MTU application unit 403.

With the above-described configuration, the present exemplary embodiment can perform the communication by using a packet of the size determined according to the changed MTU when one logical network control apparatus performs the VPN connection with a plurality of logical network control apparatuses.

In step S2215, the logical network control unit 500 of the logical network control apparatus 103b determines whether the connection discontinuation information has been transmitted from the logical network control apparatus 103c whose VPN connection has been discontinued. In the present exemplary embodiment, the logical network control apparatus 103c has not been VPN-connected with any logical network control apparatus 103 other than the logical network control apparatus 103b. Accordingly, the logical network control unit 500 determines that the connection discontinuation information has not been transmitted from the logical network control apparatus 103c in step S2215. Then, the processing advances to step S2217.

In step S2217, the logical network control unit 500 of the logical network control apparatus 103b determines whether the minimum value of the optimum MTU stored in the MTU list has been changed. In the present exemplary embodiment, the entry of the optimum MTU (1,150 bytes) in the communication with the logical network control apparatus 103c, which has been the minimum value of the optimum MTU so far, has been deleted. Accordingly, the logical network control unit 500 of the logical network control apparatus 103b determines that the minimum value of the optimum MTU has been changed.

In step S2217, the logical network control unit 500 acquires the new minimum value of the optimum MTU from the MTU list. In the present exemplary embodiment, the logical network control unit 500 acquires the optimum MTU (1,250 bytes) in the communication with the logical network control apparatus 103b.

After acquiring the minimum value of the optimum MTU in step S2217, the processing advances to step S2218.

In step S2218, the event control unit 501 of the logical network control apparatus 103b transmits the changed optimum MTU to the network-connected apparatus 102b on the LAN 101b, on which the MTU notification event is registered.

After receiving the event transmitted in step S2218 from the logical network control apparatus 103b with the event control unit 401, the network-connected apparatus 102b uses the MTU application unit 403 to change the MTU to be applied.

As described above, the logical network control unit 500 of the logical network control apparatus 103a performs the following processing in step S2301 when the status of the logical connection with the LAN 101b (the second network) and another network is changed.

That is, the logical network control unit 500 receives the notification of connection information (the connection discontinuation information) from the logical network control apparatus 103b. Then, the logical network control apparatus 500 acquires, from the received connection information, information corresponding to the data length of a communication packet that can be transmitted via the logical connection without being divided.

In the present exemplary embodiment, the logical network control unit 500 receives the connection discontinuation information (the connection information) with respect to the logical network control apparatus 103c when the logical connection (VPN) with each of the LAN 101b (the second network) and another network (the LAN 101c) is discontinued.

In step S2303, the logical network control unit 500 acquires information (the optimum MTU) corresponding to the data length of a communication packet that can be transmitted to the LAN 101b (the second network) without being divided from the received connection discontinuation information.

Furthermore, the event control unit 401 of the logical network control apparatus 103a notifies the information (the optimum MTU) corresponding to the data length acquired in step S2304 to the network-connected apparatus 102a (the communication apparatus) on the LAN 101a (the first network)

With the above-described configuration, the present exemplary embodiment can perform the communication by using a packet of the size determined according to the changed data length when the data length of a communication packet is changed.

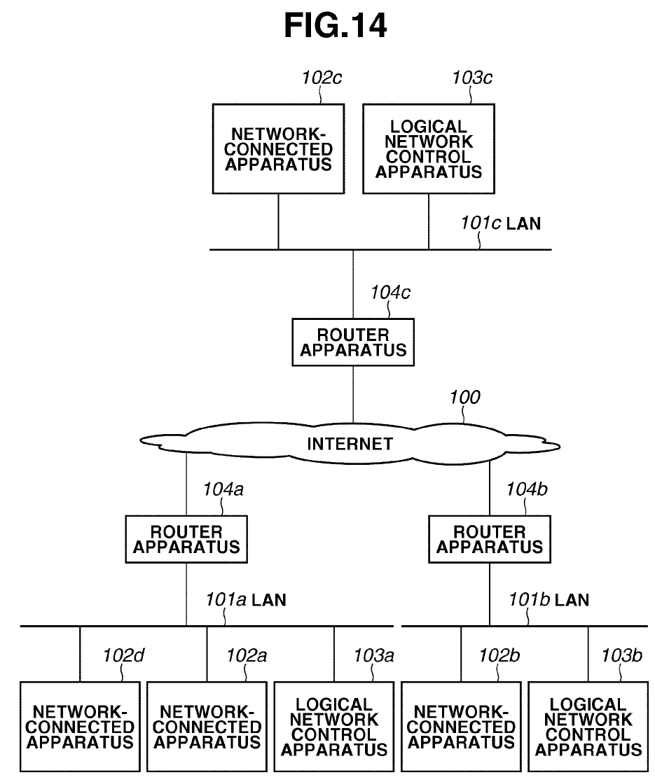

A third exemplary embodiment of the present invention will now be described in detail below with reference to drawings, focusing on points of difference from the first and the second exemplary embodiments. FIG. 14 illustrates an example of a configuration of a network system according to the third exemplary embodiment of the present invention.

Referring to FIG. 14, a network-connected apparatus 102d is connected to the LAN 101a. In the present exemplary embodiment, the network-connected apparatuses 102a, 102b, 102c, and 102d are the communication apparatuses having similar functions.

Furthermore, the network-connected apparatuses 102a, 102b, 102c, and 102d belong to the same multicast group and use the same multicast address “224.1.1.1”.

In the present exemplary embodiment, it is supposed that the logical network control apparatus 103a and the logical network control apparatus 103b have already started a VPN connection. It is also supposed here that in the same way, the logical network control apparatus 103a and the logical network control apparatus 103c has already started a VPN connection.

Note that the logical network control apparatus 103a is a relay apparatus that connects the LAN 101a (the first network) to the logical network (VPN).

Furthermore, the logical network control apparatus 103a relays communication data received from the network-connected apparatuses 102a and 102d on the LAN 101a to the network-connected apparatus 102 on another network that has been VPN-connected. Furthermore, the logical network control apparatuses 103a, 103b, and 103c are the relay apparatuses having similar functions.

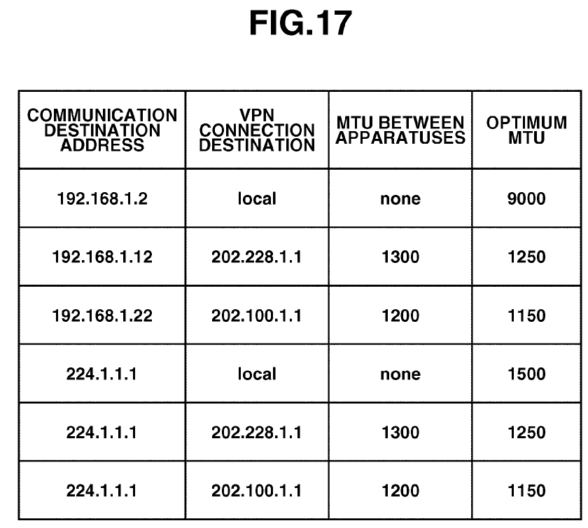

FIG. 17 illustrates an example of an MTU list stored in the logical network control apparatus 103a. A connection destination address field holds a unicast address or a multicast address. The network-connected apparatus 102d is provided with a unicast address “192.168.1.2” and a multicast address “224.1.1.1”. The network-connected apparatus 102b is provided with a unicast address “192.168.1.12” and a multicast address “224.1.1.1”. The network-connected apparatus 102c is provided with a unicast address “192.168.1.22” and a multicast address “224.1.1.1”.

A parameter “local” in a VPN connection destination field in the MTU list indicates that the network-connected apparatus 102d exists in a link local of the network-connected apparatus 102a.

An IP address “202.228.1.1” in a VPN connection destination field in the MTU list is an address that provides an access to the logical network control apparatus 103b. In the present exemplary embodiment, the IP address “202.228.1.1” is the address of the router apparatus 104b, and a setting for DMZ and port forwarding is performed with respect to the router apparatus 104b.

The router apparatus 104b can transfer a packet to the logical network control apparatus 103b. The address is used in communicating with the logical network control apparatus 103b via the Internet.

The IP address “202.100.1.1”, which is stored in the MTU list is the address that provides an access to the logical network control apparatus 103c. In the present exemplary embodiment, the IP address “202.100.1.1” is the address of the router apparatus 104c, and a setting for DMZ and port forwarding is performed with respect to the router apparatus 104c.

The router apparatus 104c can transfer a packet to the logical network control apparatus 103c. The address is used in communicating with the logical network control apparatus 103c via the Internet.

Furthermore, a parameter “none” stored in an MTU between apparatuses field indicates that no VPN connection has been performed within a path to the connection destination address (“192.168.1.2”). In the entry, the optimum MTU is 9,000 bytes. This is greater than the maximum value of the MTU in the Ethernet.

Accordingly, it is indicated that the connection destination address complies with a jumbo frame of the Ethernet. That is, it is indicated that a communication packet whose size is 9,000 bytes or smaller can be transmitted to the connection destination address.

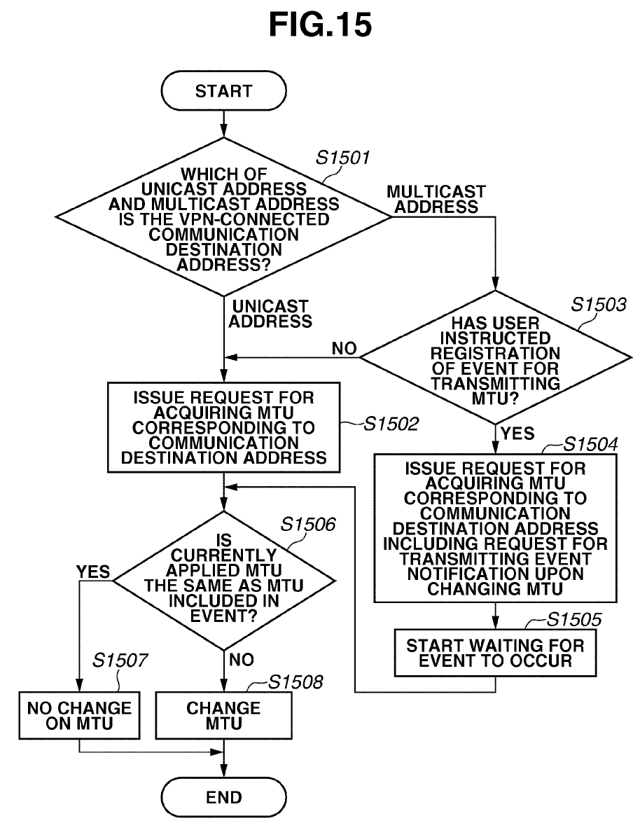

Now, an operation of the network-connected apparatus 102a according to the present exemplary embodiment will be described in detail below with reference to FIG. 15. FIG. 15 is a flow chart that illustrates an example of a flow of processing for starting a communication based on the VPN connection of the network-connected apparatus 102a according to the present exemplary embodiment.

Referring to FIG. 15, in step S1501, the device control unit 400 of the network-connected apparatus 102a determines which of a unicast address and a multicast address the VPN-connected communication destination address is.

If it is determined in step S1501 that the VPN-connected communication destination address is the unicast address, then the processing advances to step S1502. On the other hand, if it is determined in step S1501 that the connection destination address is the multicast address, then the processing advances to step S1503.

In step S1502, the device control unit 400 issues, to the event control unit 401, a request for acquiring the MTU corresponding to the connection destination address with respect to the logical network control apparatus 103a. Then, the event control unit 401 acquires the optimum MTU corresponding to the connection destination address from the logical network control apparatus 103a. Then, the processing advances to step S1506.

In step S1503, the event control unit 401 determines whether the request for registering the MTU notification event has been issued. If it is determined by the event control unit 401 in step S1503 that the registration of the MTU notification event has been instructed by a user and an application (YES in step S1503), then the processing advances to step S1504. On the other hand, if it is determined in step S1503 that the registration of the MTU notification event has not been instructed by a user and an application (NO in step S1503), then the processing advances to step S1502.

In step S1504, the event control unit 401 issues the request for registering the MTU notification event on the logical network control apparatus 103a and a request for acquiring the MTU corresponding to the connection destination address (the multicast address). Here, in this case, the processing for registering the MTU notification event described above with reference to FIGS. 6, 7, and 8 is performed.

Furthermore, the event control unit 401 acquires the optimum MTU corresponding to the connection destination address from the logical network control apparatus 103a. Then, the processing advances to step S1505.

In step S1505, the event control unit 401 starts waiting for the event for notifying the registered MTU. Then, the processing advances to step S1506.

After performing the above-described processing, the optimum MTU is notified to the network-connected apparatus 102a when the status of the VPN connection is changed as in the first and the second exemplary embodiments.

In step S1506, the MTU application unit 403 compares the optimum MTU acquired in step S1502 or S1504 with the current optimum MTU to determine whether the acquired optimum MTU is the same as the optimum MTU currently set in the system. If it is determined in step S1506 that the acquired optimum MTU is the same as the MTU currently set in the system (YES in step S1506), then the processing advances to step S1507. On the other hand, if it is determined in step S1506 that the acquired optimum MTU is different from the MTU currently set in the system (NO in step S1506), then advances to step S1508.

In step S1507, the MTU application unit 403 does not change the MTU. Then, the processing for acquiring the MTU ends.

In step S1508, the MTU application unit 403 performs the processing for changing (substitutes) the MTU in the communication with the connection destination address with the acquired optimum MTU. Then, the processing for acquiring the MTU ends.

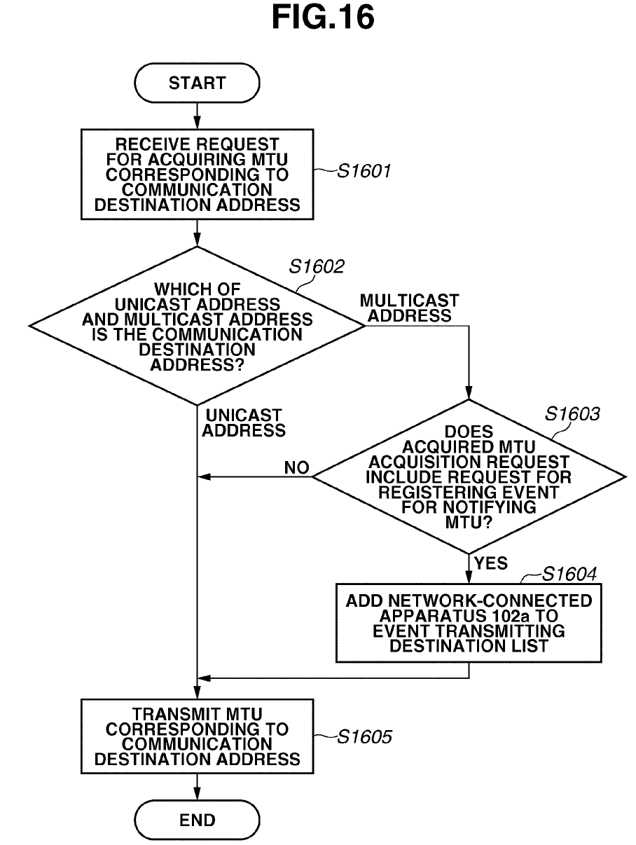

Now, an operation of the logical network control apparatus 103a according to the present exemplary embodiment will be described in detail below with reference to FIG. 16. FIG. 16 is a flow chart that illustrates an example of a flow of processing performed at the start of the VPN-connected communication by the logical network control apparatus 103a according to the present exemplary embodiment.

Referring to FIG. 16, in step S1601, the event control unit 501 of the logical network control apparatus 103a receives a request for acquiring the MTU from the network-connected apparatus 102a. Then, the processing advances to step S1602.

In step S1602, the event control unit 501 determines which of a unicast address and a multicast address the connection destination address included in the MTU acquisition request received in step S1601 is.

More specifically, the event control unit 501 determines the type of the connection destination address of the communication by the network-connected apparatus 102a (the communication apparatus).

If it is determined in step S1602 that the connection destination address is the multicast address, then the processing advances to step S1603. On the other hand, if it is determined in step S1602 that the connection destination address is the unicast address, then the processing advances to step S1605.

In step S1603, the event control unit 501 determines whether the request for registering the MTU notification event is included in the received MTU acquisition request.

If it is determined in step S1603 that the request for registering the MTU notification event is not included in the received MTU acquisition request (NO in step S1603), then the processing advances to step S1605. On the other hand, if it is determined in step S1603 that the request for registering the MTU notification event is included in the received MTU acquisition request (YES in step S1603), then the processing advances to step S1604.

In step S1604, the event control unit 501 adds the network-connected apparatus 102a as the event transmission destination for the case where the optimum MTU of the connection destination address, which is included in the MTU acquisition request received in step S1601, is changed. Then, the processing advances to step S1605.

More specifically, the event control unit 501 notifies the new minimum value of the optimum MTU acquired when the optimum MTU is changed according to a result of the determination in step S1602 as in the first and the second exemplary embodiments.

Note that in the case where the VPN for the communication using the multicast address is discontinued, the network-connected apparatus 102a registered as the destination of transmission of the event is deleted. Accordingly, the length of a packet to be transmitted to the multicast address is changed accordingly as the optimum MTU is changed due to the change in the VPN connection status.

Furthermore, in the above-described case where the VPN for the communication using the multicast address is discontinued, the packet size determined according to the status of the VPN connection after the discontinuation is set on the network-connected apparatus 102a.

In step S1605, the event control unit 501 transmits the optimum MTU corresponding to the connection destination address included in the MTU acquisition request received in step S1601 to the network-connected apparatus 102a. Then, the processing for notifying the MTU and registering the event at the start of the communication ends.

Here, the following processing is performed by the logical network control apparatus 103a in the case where the network-connected apparatus 102a communicates with the connection destination address “192.168.1.2” of the logical network control apparatus 102d.

That is, in this case, in step S1602, the event control unit 501 of the logical network control apparatus 103a determines that the connection destination address included in the MTU acquisition request received in step S1601 is the unicast address.

In step S1605, the event control unit 501 acquires, from the MTU list illustrated in FIG. 17, the optimum MTU (9,000 byte) corresponding to the address that provides an access to the network-connected apparatus 102d. Then, the event control unit 501 notifies the acquired optimum MTU to the network-connected apparatus 102a.

By performing the above-described processing, the present exemplary embodiment can perform the communication by using a packet of the size determined according to the MTU corresponding to the packet size in the jumbo frame of the Ethernet.

Furthermore, the following processing is performed by the logical network control apparatus 103a in the case where the network-connected apparatus 102a communicates with the multicast address “224.1.1.1”.

That is, in step S1602, the event control unit 501 of the logical network control apparatus 103a determines that the connection destination address included in the MTU acquisition request received in step S1601 is the multicast address.

In step S1603, the event control unit 501 determines whether the request for registering the MTU notification event is included in the received MTU acquisition request. In the present exemplary embodiment, the event control unit 501 determines that the event registration request is included in the received MTU acquisition request. Then, the processing advances to step S1604.

In step S1604, the event control unit 501 adds the network-connected apparatus 102a as the event transmission destination in the case where the optimum MTU of the connection destination address (the multicast address) included in the MTU acquisition request received in step S1601 is changed. Then, the processing advances to step S1605.

In step S1605, the event control unit 501 transmits the minimum value of the optimum MTU (1,150 bytes) corresponding to the connection destination address (the multicast address) included in the MTU acquisition request received in step S1601 to the network-connected apparatus 102a.

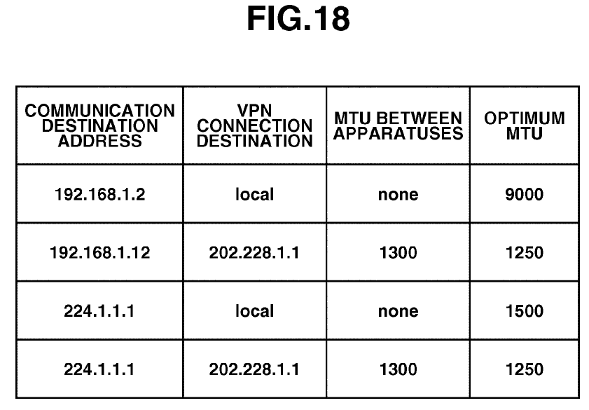

Now, processing performed in the case where the logical network control apparatus 103a has discontinued the VPN connection with the logical network control apparatus 103c will be described below with reference to FIG. 18. FIG. 18 illustrates an example of an MTU list stored in the logical network control apparatus 103a after discontinuing the VPN connection with the logical network control apparatus 103c.

It is supposed here that the network-connected apparatus 102a has already acquired the minimum value of the optimum MTU of the multicast address “224.1.1.1” (1,150 bytes). In addition, it is supposed here that the MTU notification event has already been registered on the logical network control apparatus 103a.

The event control unit 501 of the logical network control apparatus 103a determines that the optimum MTU of the multicast address “224.1.1.1” has been changed. Furthermore, the event control unit 501 of the logical network control apparatus 103a acquires the new optimum MTU (1,250 bytes).

In addition, the event control unit 501 of the logical network control apparatus 103a notifies the network-connected apparatus 102a, which is the destination of the registration of the MTU notification event, that the optimum MTU of the address “224.1.1.1” has been changed to 1,250 bytes.

The network-connected apparatus 102a receives the MTU notification event with the event control unit 410. Furthermore, the network-connected apparatus 102a changes the MTU for a communication packet to be transmitted to the address “224.1.1.1” to 1,250 bytes.

With the above-described configuration, the network-connected apparatus 102a can perform the communication by using a packet of the size determined according to the changed MTU also in the case where the VPN connection is discontinued in the communication performed based on the multicast address. As a result, the throughput of data transmitted by multicasting can be increased.

Note that if the network-connected apparatus 102a does not perform the registration of the MTU notification event in the above-described example, then the logical network control apparatus 103a does not notify the change in the optimum MTU. Accordingly, in this case, the network-connected apparatus 102a can continue the communication with the logical network control apparatus 103c by the optimum MTU (1,150 bytes)

As described above, in the present exemplary embodiment, whether to register the MTU notification event can be appropriately selected. Accordingly, the present exemplary embodiment can perform the communication by a constant MTU even if the status of connection to the logical network (VPN) is changed when it is determined useful to perform the communication with the constant MTU.

As described above, the logical network control apparatus 103a according to the present exemplary embodiment performs the determination on the connection destination address of the communication performed by the network-connected apparatus (the communication apparatus).

Furthermore, if it is determined that the type of the connection destination address of the communication by the network-connected apparatus is the unicast address, then the logical network control apparatus 103a according to the present exemplary embodiment notifies the optimum MTU corresponding to the connection destination address.

On the other hand, if it is determined that the type of the connection destination address of the communication by the network-connected apparatus is the multicast address, then the logical network control apparatus 103a according to the present exemplary embodiment performs the processing related to the registration of the MTU notification event. Furthermore, the logical network control apparatus 103a according to the present exemplary embodiment notifies the smallest optimum MTU of the optimum MTUs corresponding to the connection destination address.

According to the present exemplary embodiment having the above-described configuration, the network-connected apparatus 102a can perform the communication by using a packet of the size determined according to the MTU corresponding to the packet size in the jumbo frame of the Ethernet in the communication performed by unicasting.

Furthermore, the present exemplary embodiment having the above-described configuration can perform the communication by using a packet of the size determined according to the changed MTU in the case where the VPN is constructed or discontinued (that is, when the status of connection is changed) in the communication performed by multicasting. Note that in the present exemplary embodiment, the processing performed in the case where the VPN connection is discontinued is described. However, the present exemplary embodiment can also be implemented in the case where a VPN connection is newly constructed.

Furthermore, in the present exemplary embodiment, it is determined which of the unicast address or the multicast address the VPN-connected communication destination address is in steps S1501 (FIG. 15) and S1602 (FIG. 16). However, the present exemplary embodiment is not limited to this. That is, it is also useful if a broadcast address or an anycast address is used instead of the multicast address.

Furthermore, in the present exemplary embodiment, the IPv4 protocol is used. However, the present exemplary embodiment is not limited to this. That is, it is also useful if an arbitrarily designated protocol, such as IPv6, is used.

The present invention can also be achieved by providing a system or an apparatus with a storage medium storing program code of software implementing the functions of the embodiments and by reading and executing the program code stored in the storage medium with a computer of the system or the apparatus (a CPU or a micro processing unit (MPU)).

In this case, the program code itself, which is read from the storage medium, implements the functions of the embodiments described above, and accordingly, the storage medium storing the program code constitutes the present invention.

As the storage medium for supplying such program code, a floppy disk, a hard disk, an optical disk, a magneto-optical disk (MO), a CD-ROM, a magnetic tape, a nonvolatile memory card, a ROM, and a digital versatile disc (DVD (DVD-recordable (DVD-R), DVD-rewritable (DVD-RW))), for example, can be used.

In addition, the functions according to the embodiments described above can be implemented not only by executing the program code read by the computer, but also implemented by the processing in which an OS or the like carries out a part of or the whole of the actual processing based on an instruction given by the program code.

Further, in another aspect of the embodiment of the present invention, after the program code read from the storage medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

While the present invention has been described with reference to exemplary embodiments, it is to be understood that the present invention is not limited to the disclosed exemplary embodiments. The scope of the following claims is to be accorded the broadest interpretation so as to encompass all modifications, equivalent structures, and functions.

This application claims priority from Japanese Patent Application No. 2008-008028 filed Jan. 17, 2008, which is hereby incorporated by reference herein in its entirety.

What is claimed is:

1. A relay apparatus connected to a first network and configured to construct a connection between the first network and another network so that a communication packet can be transmitted between the first network and the another network, the relay apparatus comprising:
a relay unit configured to relay communication data received from a communication apparatus on the first network to a communication apparatus on the another network via the connection;
an acquisition unit configured to acquire information corresponding to a data length of a communication packet that can be transmitted via the connection without being divided according to a change of connection status of the another network; and
a notification unit configured to notify the information acquired by the acquisition unit to the communication apparatus on the first network.

2. A relay apparatus connected to a first network and configured to construct a connection between the first network and a second network so that a communication packet can be transmitted between the first network and the second network, the relay apparatus comprising:
a relay unit configured to relay communication data received from a communication apparatus on the first network to a communication apparatus on the second network via a second relay apparatus connected to the second network;
an acquisition unit configured to, based on connection information notified from the second relay apparatus according to a change of connection status of the second relay apparatus between the second network and another network, acquire information corresponding to a data length of a communication packet that can be transmitted via the connection after the change of connection status without being divided; and
a notification unit configured to notify the information acquired by the acquisition unit to the communication apparatus on the first network.

3. The relay apparatus according to claim 1, wherein the relay apparatus is configured to construct a logical connection between the first network and the another network, and
wherein the notification unit is configured to notify the information according to addition or deletion of another network to or from the logical connection.

4. The relay apparatus according to claim 1, wherein the notification unit is configured to compare the information acquired by the acquisition unit with predetermined information and to notify the information acquired by the acquisition unit according to a result of the comparison.

5. The relay apparatus according to claim 1, further comprising a determination unit configured to determine a type of a destination address in a communication performed by the communication apparatus on the first network,
wherein the notification unit is configured to notify the information acquired by the acquisition unit according to a result of the determination by the determination unit.

6. A method for notifying information performed by a relay apparatus connected to a first network, the method comprising:
constructing a connection between the first network and another network so that a communication packet can be transmitted between the first network and the another network;
relaying communication data received from a communication apparatus on the first network to a communication apparatus on the another network via the connection;
acquiring information corresponding to a data length of a communication packet that can be transmitted via the connection without being divided according to a change of connection status of the another network; and
notifying the acquired information to the communication apparatus on the first network.

7. A method for notifying information performed by a relay apparatus connected to a first network, the method comprising:
constructing a connection between the first network and a second network so that a communication packet can be transmitted between the first network and the second network;
relaying communication data received from a communication apparatus on the first network to a communication apparatus on the second network via a second relay apparatus connected to the second network;
based on connection information notified from the second relay apparatus according to a change of connection status of the second relay apparatus between the second network and another network, acquiring information corresponding to a data length of a communication packet that can be transmitted via the connection after the change of connection status without being divided; and
notifying the acquired information to the communication apparatus on the first network.

8. A computer-readable storage medium storing computer-executable instructions for causisng a computer connected to a first network to perform a method comprising:
constructing a connection between the first network and another network so that a communication packet can be transmitted between the first network and the another network;
relaying communication data received from a communication apparatus on the first network to a communication apparatus on the another network via the connection;
acquiring information corresponding to a data length of a communication packet that can be transmitted via the connection without being divided according to a change of connection status of the another network; and
notifying the acquired information to the communication apparatus on the first network.

9. A computer-readable storage medium storing computer-executable instructions for causisng a computer connected to a first network to perform a method comprising:
constructing a connection between the first network and a second network so that a communication packet can be transmitted between the first network and the second network;
relaying communication data received from a communication apparatus on the first network to a communication apparatus on the second network via a second relay apparatus connected to the second network;
based on connection information notified from the second relay apparatus according to a change of connection status of the second relay apparatus between the second network and another network, acquiring information corresponding to a data length of a communication packet that can be transmitted via the connection after the change of connection status without being divided; and
notifying the acquired information to the communication apparatus on the first network.
